(19) United States
(12) Patent Application Publication
(10) Pub. No.: US 2009/0015980 A1
(43) Pub. Date: Jan. 15, 2009

(54) SOLENOID VALVE DRIVING CIRCUIT AND SOLENOID VALVE

(75) Inventors: Yoshihiro FUKANO, Moriya-shi (JP); Masami Yoshida, Ryugasaki-shi (JP); Yoshitada Doi, Koshigaya-shi (JP); Shigeharu Oide, Adachi-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SMC Kabushiki Kaisha, Chiyoda-ku (JP)

(21) Appl. No.: 12/140,578

(22) Filed: Jun. 17, 2008

(30) Foreign Application Priority Data
Jul. 9, 2007 (JP) 2007-179935

(51) Int. Cl. H01H 47/04

(52) U.S. Cl. 361/194

(57) ABSTRACT

A current detection circuit generates a pulse signal Sd based on a voltage Vd corresponding to a current I flowing through a solenoid coil, and feeds the pulse signal Sd back to a PWM circuit of a switch controller. The PWM circuit generates a pulse signal Sr having a predetermined duty ratio, based on a comparison between the fed back pulse signal Sd and a voltage value corresponding to a first current value or a second current value, and supplies the pulse signal Sr to a pulse supplying unit. The pulse supplying unit supplies the pulse signal Sr as a first pulse signal S1 and/or a second pulse signal S2 to a gate terminal G of a MOSFET.

### BACKGROUND OF THE INVENTION

1. Field of the Invention

The present invention relates to a solenoid valve driving circuit in which, after a first voltage is impressed on the solenoid coil of a solenoid valve for driving the solenoid valve, a second voltage is impressed on the solenoid coil and the driven state of the solenoid valve is maintained, as well as to a solenoid valve having such a solenoid valve driving circuit.

2. Description of the Related Art

Conventionally, it has been widely practiced to arrange a solenoid valve within a fluid passage, and by impressing a voltage on a solenoid coil of the solenoid valve from a solenoid valve driving circuit, the solenoid valve is energized to open and close the fluid passage. In this case, after the solenoid valve is driven by impressing a first voltage on the solenoid coil of the solenoid valve from the solenoid valve driving circuit, the driven state of the solenoid valve is maintained by impressing a second voltage on the solenoid coil from the solenoid valve driving circuit.

Recently, concerning the aforementioned solenoid valve, it has been desired that the driven state be maintained with low power consumption. In Japanese Patent No. 3777265, it has been proposed that, within a time period at which the driven state is maintained, and as a result of controlling conduction between a rectifying circuit, which rectifies the power source voltage of an AC power source, and the solenoid coil by means of a switch, energization and deenergization of the solenoid coil is carried out repeatedly, so that the driven state of the solenoid valve can be maintained with a lower level of power consumption.

Incidentally, in the above-mentioned Japanese Patent No. 3777265, current runs through the solenoid coil by supplying to the solenoid coil the power source voltage, which is rectified by the rectifying circuit. In this case, the current tends to vary over time as a result of various factors, such as changes in electrical resistance in the solenoid coil induced by temperature changes of the solenoid coil, ripples in the rectified power source voltage (first voltage and second voltage) impressed on the solenoid coil, and due to vibrations or shocks and the like, which are imparted to the solenoid valve from the exterior thereof. Owing thereto, within the time period at which the driven state of the solenoid valve is maintained, so as to prevent the above-mentioned various factors from occurring and causing stoppage of the solenoid valve, a current, which takes into consideration the aforementioned various factors, is superimposed on the minimal required current for maintaining the driven state. Accordingly, even when the above-mentioned various factors do not occur, the current taken in consideration of these factors still flows through the solenoid coil, and hence, electrical power savings of the solenoid valve driving circuit and the solenoid valve cannot be promoted.

Further, as a result of the current that flows through the solenoid coil being large, when driving of the solenoid valve is halted after maintaining the driven state, the solenoid valve cannot be stopped in a short time period.

Moreover, in the case that a plurality of AC power sources, having different power source voltages, are prepared and utilized on the side of users of the solenoid valves, on the manufacturer's side, even if there are solenoid valve driving circuits and solenoid valves having roughly the same capability with respect to opening/closing the same fluid passage, because it is necessary to separately manufacture the solenoid valve driving circuits and solenoid valves corresponding to differences of the various power source voltages, manufacturing costs tend to rise.

Still further, because the electrical power consumption of a solenoid valve driving circuit and a solenoid valve corresponding to the case of a relatively high power source voltage (e.g., a maximum value of about 282 V in the case of an AC power source for use with a 200 V alternating current) is larger than the electrical power consumption of a solenoid valve driving circuit and a solenoid valve corresponding to the case of a relatively low power source voltage (e.g., a maximum value of about 141 V in the case of an AC power source for use with a 100 V alternating current), on the side of a user equipped with an AC power source having a relatively high power source voltage, electrical power savings of the solenoid valve driving circuit and the solenoid valve cannot be achieved.

Still further, the current flowing through the solenoid coil during a time period when the solenoid valve is driven is larger than the current that flows through the solenoid coil during a time period when the driven state of the solenoid valve is maintained. Owing thereto, the electrical power consumption during the time period when the solenoid valve is driven is greater than the electrical power consumption during the time period when the driven state of the solenoid valve is maintained. Notwithstanding, in Japanese Patent No. 3777265, electrical power savings countermeasures are carried out only with respect to the time period when the driven state of the solenoid valve is maintained, and therefore it cannot be said with confidence that such electrical power savings countermeasures are carried out highly efficiently with respect to the solenoid valve and the solenoid valve driving circuit.

### SUMMARY OF THE INVENTION

The present invention has the object of providing a solenoid valve driving circuit and a solenoid valve, which are capable of realizing, in one sweep, a reduction in electrical power consumption, a rapidly responsive drive control for the solenoid valve, and a reduction in costs.

Further, the present invention has the object of providing a solenoid valve driving circuit and solenoid valve, which are capable of carrying out electrical power savings with high efficiency.

In accordance with the present invention, a solenoid valve driving circuit is provided, in which, after a first voltage is impressed on the solenoid coil of a solenoid valve for driving the solenoid valve, a second voltage is impressed on the solenoid coil and a driven state of the solenoid valve is maintained,

the solenoid valve driving circuit being electrically connected, respectively, to an alternating current power source and to the solenoid coil, and further including a rectifying circuit, a switch controller, a switch, and a current detector,

wherein the rectifying circuit rectifies a power source voltage of the alternating current power source,

wherein the current detector detects a current flowing through the solenoid coil, and outputs a detection result, as a current detection value, to the switch controller,

wherein the switch controller generates a first pulse signal based on a comparison between a predetermined activation current value and the current detection value, and a second pulse signal based on a comparison between a predetermined holding current value and the current detection value, and supplies the first pulse signal and the second pulse signal to the switch, and

wherein the switch applies the rectified power source voltage as the first voltage to the solenoid coil during a time period when the first pulse signal is supplied thereto, and applies the rectified power source voltage as the second voltage to the solenoid coil during a time period when the second pulse signal is supplied thereto.

Herein, within the time period that the solenoid valve is driven, the necessary excitation force (activation force) for driving a movable core (plunger) that makes up the solenoid valve and for driving a valve plug installed onto the end of the plunger, and the necessary excitation force (holding force) needed to maintain (hold) the plunger and the valve plug at a predetermined position during a time period in which the driven state of the solenoid valve is maintained, are values resulting from multiplying the number of windings (turns) of the solenoid coil and the current that flows through the solenoid coil (respective excitation forces=number of windings×current). Therefore, assuming that the activation force needed to drive the solenoid valve, the minimum necessary holding force for maintaining the driven state, and the number of windings, respectively, are known ahead of time, an optimal current (activation current value) corresponding to the activation force, as well as an optimal current value (holding current) corresponding to the holding force, can easily be calculated.

Further, at the time of supplying the first pulse signal or the second pulse signal to the switch from the switch controller, the rectified power source voltage is applied to the solenoid coil as a first voltage or a second voltage, whereby the supply of electrical power to the solenoid coil is carried out from the AC power source, and thus, the current flowing through the solenoid coil increases. On the other hand, at times when supply of the first pulse signal or the second pulse signal to the switch from the switch controller is halted, the supply of electrical power is stopped, and thus, the current flowing through the solenoid coil is reduced. Accordingly, by timewise controlling the supply of the first pulse signal and the second pulse signal with respect to the switch, the current flowing through the solenoid coil can be maintained at desired current values (i.e., an activation current value optimal for the activation force, and a holding current value optimal for the holding force).

In the present invention, the current detector detects the current flowing through the solenoid coil, and the current detection value is fed back to the switch controller. In the switch controller, the first pulse signal is generated based on a comparison between the activation current value, as an optimal current corresponding to the activation force, and the fed back current detection value, whereas the second pulse signal is generated based on a comparison between the holding current value, as an optimal current corresponding to the holding force, and the fed back current detection value. The switch applies the first voltage to the solenoid coil only during times corresponding to a pulse width of the first pulse signal, or applies the second voltage to the solenoid coil only during times corresponding to a pulse width of the second pulse signal.

That is, during the time period when the solenoid valve is driven, the switch controller generates the first pulse signal so that the current detection value becomes the activation current value corresponding to the activation force, and supplies the first pulse signal to the switch, whereby the switch, based on the pulse width of the first pulse signal, controls the application time of the first voltage to the solenoid coil. Owing thereto, the current flowing through the solenoid coil is maintained at the activation current value corresponding to the activation force, and the activation force induced by such a current is imposed to energize the plunger and the valve plug.

More specifically, on the side of the user of the solenoid valve, in the case that an AC power source has been prepared beforehand having a relatively high power source voltage (e.g., a maximum value of about 282 V in the case of an AC power source for use with a 200 V alternating current), and a solenoid valve that uses a relatively low power source voltage (e.g., a maximum value of about 141 V in the case of an AC power source for use with a 100 V alternating current) is applied with respect to such an AC power source, the activation current value is set in the switch controller at or below a rated value (rated current) of the current flowing through the solenoid coil. Then, if the pulse width of the first pulse signal is adjusted such that the current detection value becomes the thus set activation current value, the current flowing through the solenoid coil during the time period that the solenoid valve is driven is maintained at the activation current value, and thus, even for a user for whom an AC power source having a relatively high power source voltage has been prepared, power savings can be achieved for the solenoid valve driving circuit and the solenoid valve. In this case, since a power source voltage corresponding to the relatively high power source voltage and which is rectified in the rectifying circuit, is applied as the first voltage to the solenoid coil, it is possible for the solenoid valve to be driven in a shorter time.

As described above, by adjusting the pulse width of the first pulse signal in the switch controller, the current that flows through the solenoid coil can be maintained at the activation current value, which is at or below the rated current. Therefore, on the side of the manufacturer, without concern to any difference in the rectified power source voltage supplied to the solenoid coil via the rectifying circuit from the AC power source provided on the user's side, the solenoid valve driving circuit and the solenoid valve can be made commonly usable in accordance with a relatively low power source voltage, wherein by providing such a commonly usable solenoid valve driving circuit and solenoid valve to the user, costs can be reduced.

Accordingly, with the present invention, by generating the first pulse signal based on a comparison between the current detection value that is fed back to the switch controller from the current detector and the activation current value during a time period in which the solenoid valve is driven, power savings of the solenoid valve driving circuit and the solenoid valve, common usage and cost reduction, and a rapidly-responsive drive control for the solenoid valve, are all capable of being realized.

On the other hand, during a time period in which the driven state of the solenoid valve is maintained, the switch controller generates a second pulse signal so that the current detection value becomes the holding current value corresponding to the holding force, whereupon the second pulse signal is supplied to the switch, and the switch thereby controls the application time at which the second voltage is applied to the solenoid coil. Owing thereto, the current flowing through the solenoid coil is maintained at the holding current value corresponding to the holding force, and the holding force induced by the current is imposed to energize the plunger and the valve plug.

Accordingly, with the present invention, by generating the second pulse signal based on a comparison between the current detection value that is fed back to the switch controller from the current detector during a time period in which the driven state of the solenoid valve is maintained and the holding current value, the driven state of the solenoid valve can be maintained with smaller power consumption, and further, the solenoid valve can be stopped in a short time.

Further, by feeding back the current detection value to the switch controller, even if the current tends to vary over time due to changes in electrical resistance inside the solenoid coil or due to ripples in the rectified power source voltage as a result of temperature changes in the solenoid coil, the second pulse signal is generated responsive to such changes, whereby a solenoid valve driving circuit and a solenoid valve, which are capable of responding to changes in the use environment, such as changes in electrical resistance and ripples or the like, can be realized.

In this manner, with the present invention, a reduction in electrical power consumption of the solenoid valve driving circuit and the solenoid valve, rapidly responsive drive control for the solenoid valve, and a reduction in costs for the solenoid valve driving circuit and the solenoid valve, can all be realized together in one sweep.

Further, in the present invention, because electrical power consumption can be reduced not only during the time period when the driven state of the solenoid valve is maintained, but also during the time period in which the solenoid valve is driven, electrical power savings of the solenoid valve driving circuit and the solenoid valve can be carried out with high efficiency.

Herein, the switch controller preferably includes:

a single pulse generating circuit for generating a single pulse;

a short pulse generating circuit, which, during a time period in which the solenoid valve is driven, generates a first short pulse having a pulse width shorter than a pulse width of the single pulse based on a comparison between the activation current value and the current detection value, whilst, during a time period in which a driven state of the solenoid valve is maintained, generates a second short pulse having a pulse width shorter than the pulse width of the first short pulse based on a comparison between the holding current value and the current detection value; and

a pulse supplying unit, which, during the time period in which the solenoid valve is driven, supplies the first short pulse to the switch as the first pulse signal after the single pulse has been supplied to the switch as the first pulse signal, whilst, during the time period in which the driven state of the solenoid valve is maintained, supplies the second short pulse to the switch as the second pulse signal.

In this case, in the time period during which the solenoid valve is driven, after the rectified power source voltage has been impressed as the first voltage on the solenoid coil only during a time corresponding to the pulse width of the single pulse, the switch then impresses the first voltage on the solenoid coil only during a time corresponding to the pulse width of the first short pulse. As a result, in the time period during which the solenoid valve is driven, after the current flowing through the solenoid coil has risen up to the activation current value within a time corresponding to the pulse width of the single pulse, the activation current value is maintained by a switching operation of the switch based on the first short pulse. Owing thereto, the solenoid valve driving circuit and the solenoid valve can be made commonly usable, and costs can be reduced easily. In particular, in the case that an AC power source having a relatively high power source voltage is electrically connected to the solenoid coil through the solenoid valve driving circuit and the solenoid valve is driven thereby, the solenoid valve is capable of being driven in a short time. Further, by maintaining the current flowing through the solenoid coil at the activation current value, unintended or mistaken operations of the solenoid valve driving circuit and the solenoid valve caused by the input of excessive voltage (surge energy) can be reliably prevented.

On the other hand, during a time period at which the driven state of the solenoid valve is maintained, by supplying the second short pulse as the second pulse signal to the switch, the driven state of the solenoid valve can be maintained with lower power consumption, and further, the solenoid valve can be stopped in a short time.

Herein, in place of the aforementioned structure, the switch controller may preferably include:

a single pulse generating circuit for generating a single pulse;

a repeating pulse generating circuit, which, during a time period in which the solenoid valve is driven, generates a first repeating pulse having a pulse width shorter than a pulse width of the single pulse based on a comparison between the activation current value and the current detection value, whilst, during a time period in which a driven state of the solenoid valve is maintained, generates a second repeating pulse having a pulse width shorter than the pulse width of the first repeating pulse based on a comparison between the holding current value and the current detection value; and

a pulse supplying unit, which, during the time period in which the solenoid valve is driven, supplies the first repeating pulse to the switch as the first pulse signal after the single pulse has been supplied to the switch as the first pulse signal, whilst, during the time period in which the driven state of the solenoid valve is maintained, supplies the second repeating pulse to the switch as the second pulse signal.

In this case, in the time period during which the solenoid valve is driven, after the rectified power source voltage has been impressed as the first voltage on the solenoid coil only during a time corresponding to the pulse width of the single pulse, the switch then impresses the first voltage on the solenoid coil only during a time corresponding to the pulse width of the first repeating pulse. As a result, in the time period during which the solenoid valve is driven, after the current flowing through the solenoid coil has risen up to the activation current value within a time corresponding to the pulse width of the single pulse, the activation current value is maintained by a switching operation of the switch based on the first repeating pulse. In this case as well, the solenoid valve driving circuit and the solenoid valve can be made commonly usable, and costs can be reduced easily, and moreover, in the case that an AC power source having a relatively high power source voltage is electrically connected to the solenoid coil through the solenoid valve driving circuit and the solenoid valve is driven thereby, the solenoid valve is capable of being driven in a short time. Further, by maintaining the current flowing through the solenoid coil at the activation current value, unintended or mistaken operations of the solenoid valve driving circuit and the solenoid valve caused by the input of excessive voltage (surge energy) can be reliably prevented.

On the other hand, during a time period at which the driven state of the solenoid valve is maintained, by supplying the second repeating pulse as the second pulse signal to the switch, the driven state of the solenoid valve can be maintained with lower power consumption, and further, the solenoid valve can be stopped in a short time.

Accordingly, by providing each of the above-described structures for the switch controller, common usage and cost reduction of the solenoid valve driving circuit and the solenoid valve, driving of the solenoid valve in a short time, power savings of the solenoid valve driving circuit and the solenoid valve, and the ability to stop the solenoid valve in a short time, can easily be realized.

Further, the aforementioned solenoid valve driving circuit preferably further includes a smoothing circuit and a light-emitting diode,

wherein the smoothing circuit, a series circuit made up of the light-emitting diode and the switch controller, and said solenoid coil are electrically connected in parallel with respect to the rectifying circuit, the smoothing circuit smoothes the rectified power source voltage,

the smoothed power source voltage is supplied to the switch controller from the smoothing circuit through the light-emitting diode, and

wherein the light-emitting diode is capable of being illuminated when the current flows through the solenoid coil.

When the light-emitting diode is incorporated into the solenoid valve driving circuit, although it can be considered that a series circuit made up of the light-emitting diode and a current limiting resistor for causing the diode to emit light may be electrically connected in parallel with respect to the rectifying circuit, the smoothing circuit and the solenoid coil, in place of the current limiting resistor, by connecting a series circuit made up of the switch controller and the light emitting diode electrically in parallel with respect to the rectifying circuit, the smoothing circuit and the solenoid coil, since the electrical energy consumed originally by the current limiting resistor is used for operating the switch controller, a solenoid valve driving circuit of high energy use efficiency can be realized. Further, in the smoothing circuit, by supplying a smoothed power source voltage to the switch controller, the switch controller can be operated more stably.

With the above-described invention, during a time period in which the solenoid valve is driven, supply of the first pulse signal is timewise controlled based on a comparison between the activation current value and the current detection value, whilst, during a time period in which the solenoid valve is maintained in the driven state, supply of the second pulse signal is timewise controlled based on a comparison between the holding current value and the current detection value.

With such a timewise control based on the current detection value, the control can be carried out only during the time period in which the solenoid valve is driven, or alternatively, only during the time period in which the solenoid valve is maintained in the driven state.

More specifically, in order to carry out a timewise control of supply of the first pulse signal with respect to the switch, based on the current detection value only during the time period in which the solenoid valve is driven, the structure of the solenoid valve driving circuit is as follows.

Namely, a solenoid valve driving circuit is provided in which, after a first voltage is impressed on a solenoid coil of a solenoid valve for driving the solenoid valve, a second voltage is impressed on the solenoid coil and a driven state of the solenoid valve is maintained,

the solenoid valve driving circuit being electrically connected, respectively, to an alternating current power source and to the solenoid coil, and further comprising a rectifying circuit, a switch controller, a switch, and a current detector,

wherein the rectifying circuit rectifies a power source voltage of the alternating current power source,

wherein the current detector detects a current flowing through the solenoid coil, and outputs a detection result, as a current detection value, to the switch controller,

wherein the switch controller generates a first pulse signal based on a comparison between a predetermined activation current value and the current detection value, and a predetermined second pulse signal, and supplies the first pulse signal and the second pulse signal to the switch, and

wherein the switch applies the rectified power source voltage as the first voltage to the solenoid coil during a time period when the first pulse signal is supplied thereto, and applies the rectified power source voltage as the second voltage to the solenoid coil during a time period when the second pulse signal is supplied thereto.

In this case, preferably, the switch controller includes:

a single pulse generating circuit for generating a single pulse;

a short pulse generating circuit, which, during a time period in which the solenoid valve is driven, generates a first short pulse having a pulse width shorter than a pulse width of the single pulse based on a comparison between the activation current value and the current detection value, whilst, during a time period in which a driven state of the solenoid valve is maintained, generates a second short pulse having a pulse width shorter than the pulse width of the first short pulse; and

a pulse supplying unit, which, during the time period in which the solenoid valve is driven, supplies the first short pulse to the switch as the first pulse signal after the single pulse has been supplied to the switch as the first pulse signal, whilst, during the time period in which the driven state of the solenoid valve is maintained, supplies the second short pulse to the switch as the second pulse signal.

Further, in place of the aforementioned structure, the switch controller may preferably include:

a single pulse generating circuit for generating a single pulse;

a repeating pulse generating circuit, which, during a time period in which the solenoid valve is driven, generates a first repeating pulse having a pulse width shorter than a pulse width of the single pulse based on a comparison between the activation current value and the current detection value, whilst, during a time period in which a driven state of the solenoid valve is maintained, generates a second repeating pulse having a pulse width shorter than the pulse width of the first repeating pulse; and

a pulse supplying unit, which, during the time period in which the solenoid valve is driven, supplies the first repeating pulse to the switch as the first pulse signal after the single pulse has been supplied to the switch as the first pulse signal, whilst, during the time period in which the driven state of the solenoid valve is maintained, supplies the second repeating pulse to the switch as the second pulse signal.

In this manner, in the case that a timewise control of supply of the first pulse signal with respect to the switch is carried out based on the current detection value only during a time period in which the solenoid valve is driven, the aforementioned advantageous effects of the timewise control can easily be obtained.

On the other hand, in order to carry out a timewise control of supply of the second pulse signal with respect to the switch based on the current detection value only during the time period in which the solenoid valve is maintained in the driven state, the structure of the solenoid valve driving circuit is as follows.

Namely, a solenoid valve driving circuit is provided in which, after a first voltage is impressed on a solenoid coil of a solenoid valve for driving the solenoid valve, a second voltage is impressed on the solenoid coil and a driven state of the solenoid valve is maintained,

the solenoid valve driving circuit being electrically connected, respectively, to an alternating current power source and to the solenoid coil, and further comprising a rectifying circuit, a smoothing circuit, a light-emitting diode, a switch controller, a switch, and a current detector,

wherein the smoothing circuit, a series circuit made up of the light-emitting diode and the switch controller, and the solenoid coil, are electrically connected in parallel with respect to the rectifying circuit,

wherein the rectifying circuit rectifies a power source voltage of the alternating current power source,

wherein the smoothing circuit smoothes the rectified power source voltage,

wherein the smoothed power source voltage is supplied to the switch controller from the smoothing circuit through the light-emitting diode,

wherein the light-emitting diode is capable of being illuminated when the current flows through the solenoid coil,

wherein the current detector detects a current flowing through the solenoid coil, and outputs a detection result, as a current detection value, to the switch controller,

wherein the switch controller generates a predetermined first pulse signal, and a second pulse signal based on a comparison between a predetermined holding current value and the current detection value, and supplies the first pulse signal and the second pulse signal to the switch, and

wherein the switch applies the rectified power source voltage as the first voltage to the solenoid coil during a time period when the first pulse signal is supplied thereto, and applies the rectified power source voltage as the second voltage to the solenoid coil during a time period when the second pulse signal is supplied thereto.

In this case, preferably, the switch controller includes:

a single pulse generating circuit for generating a single pulse based on the smoothed power source voltage;

a short pulse generating circuit, which generates a short pulse having a pulse width shorter than a pulse width of the single pulse based on the smoothed power source voltage and a comparison between the holding current value and the current detection value; and

a pulse supplying unit, which, during the time period in which the solenoid valve is driven, supplies the single pulse to the switch as the first pulse signal, whilst, during the time period in which the driven state of the solenoid valve is maintained, supplies the short pulse to the switch as the second pulse signal.

Further, in place of the aforementioned structure, the switch controller may preferably include:

a single pulse generating circuit for generating a single pulse based on the smoothed power source voltage;

a repeating pulse generating circuit, which generates a repeating pulse having a pulse width shorter than a pulse width of the single pulse based on the smoothed power source voltage and a comparison between the holding current value and the current detection value; and

a pulse supplying unit, which, during the time period in which the solenoid valve is driven, supplies the single pulse to the switch as the first pulse signal, whilst, during the time period in which the driven state of the solenoid valve is maintained, supplies the repeating pulse to the switch as the second pulse signal.

In this manner, in the case that a timewise control of the supply of the second pulse signal with respect to the switch is carried out based on the current detection value only during a time period in which the driven state of the solenoid valve is maintained, the aforementioned advantageous effects can easily be obtained with respect to the timewise control.

Further, in each of the foregoing inventions, preferably, the switch controller adjusts the pulse width of the second pulse signal based on a vibration detection value from a vibration detector, which detects vibration of the solenoid valve.

When the holding force is reduced for the purpose of saving power, it may be envisaged that vibrations of the solenoid valve could be caused which might lead to stoppage of the solenoid valve. However, by providing the switch controller with the above-noted structure, even if the current flowing through the solenoid coil varies over time due to vibrations, by adjusting the pulse width responsive to such variations, a solenoid valve driving circuit and a solenoid valve, which are capable of responding to vibration-induced changes, can be realized.

Specifically, in the case that there are concerns over the solenoid valve coming into a stopped condition due to vibrations inside the solenoid valve caused by vibrations or shocks and the like, which are imparted to the solenoid valve from the exterior during a time period in which the driven state of the solenoid valve is maintained, by lengthening the pulse width and increasing the current (the holding current value) that flows through the solenoid coil, the holding force on the plunger and the valve plug in the solenoid valve is made to increase, whereby the solenoid valve can reliably be prevented from coming into a stopped state.

In this manner, with the present invention, since the pulse width can be set longer to increase the current (holding current value) only in cases where a high holding force is needed, power savings of the solenoid valve driving circuit and the solenoid valve can be carried out with good efficiency.

Moreover, preferably, the solenoid valve driving circuit further includes:

an energization time calculator for calculating an energization time of the solenoid coil inside of a one-time operating period of the solenoid valve based on the current detection value;

an energization time memory for storing the energization time; and

an energization time determining unit for calculating a total energization time of the solenoid coil from each of respective energization times stored in the energization time memory, and determining whether or not the total energization time is longer than a predetermined first energization time,

wherein the energization time determining unit outputs a pulse width change signal to the switch controller instructing that the pulse width of the first pulse signal be changed, when it is determined that the total energization time is longer than the first energization time, and

wherein the switch controller lengthens the pulse width of the first pulse signal based on the pulse width change signal.

Owing thereto, even in cases where the driving performance of the solenoid valve is decreased through use of the solenoid valve over a prolonged period, by setting the pulse width of the first pulse signal to be longer when the total energization time of the solenoid valve becomes longer than the first energization time, since the current (activation current value) flowing through the solenoid coil becomes larger, and the activation force can be increased, driving control of the solenoid valve can be carried out efficiently.

In this case, preferably, the energization time determining unit may externally output a usage limit notification signal notifying that the solenoid valve has reached a usage limit, when it is determined that the total energization time is longer than a second energization time, which is set to be longer than the first energization time.

Owing thereto, it becomes possible to quickly exchange the solenoid valve whenever the usage limit thereof is reached, so that reliability with respect to the usage limit (life) of the solenoid valve is improved.

Further, in place of the above-noted structure, the solenoid valve driving circuit preferably further includes:

a solenoid valve operation detector for detecting that the solenoid valve is under operation based on the current detection value;

a detection result memory for storing a detection result of the solenoid valve operation detector; and

an accumulated number of operation times determining unit for calculating an accumulated number of operation times of the solenoid valve from each of respective detection results stored in the detection result memory, and determining whether or not the accumulated number of operation times exceeds a predetermined first number of operation times,

wherein the accumulated number of operation times determining unit outputs a pulse width change signal to the switch controller instructing that the pulse width of the first pulse signal be changed, when it is determined that the accumulated number of operation times exceeds the first number of operation times, and

wherein the switch controller lengthens the pulse width of the first pulse signal based on the pulse width change signal.

If the pulse width of the first pulse signal is made longer at times when the accumulated number of operation times of the solenoid value exceeds the first number of operation times, since the current (activation current value) flowing through the solenoid coil becomes larger, and the activation force can be increased, driving control of the solenoid valve can be carried out efficiently.

In this case, it is preferable for the accumulated number of operation times determining unit to externally output a usage limit notification signal notifying that the solenoid valve has reached a usage limit, when it is determined that the accumulated number of operation times exceeds a second number of operation times, which is set to be greater than the first number of operation times.

Owing thereto, it becomes possible to quickly exchange the solenoid valve whenever the usage limit thereof is reached, so that reliability with respect to the usage limit (life) of the solenoid valve is improved.

Further, the solenoid valve driving circuit further includes:

a current detection value monitoring unit for monitoring a decrease in the current detection value during a time period in which the solenoid valve is driven,

wherein the current detection value monitoring unit externally outputs a time delay notification signal for notifying that a time delay was generated in a time period from a drive start time of the solenoid valve to a time at which the current detection value decreases, when it is determined that the time period is longer than a predetermined set time period.

Owing thereto, it becomes possible to quickly exchange a solenoid valve for which the time required for the current detection value to decrease has become longer and thus the driving performance thereof has been degraded. That is, by providing the solenoid valve driving circuit having the aforementioned structure, detection of the usage limit (life) of the solenoid valve can be carried out efficiently, based on the responsiveness of the solenoid valve during the time period in which the solenoid valve is driven.

Further, preferably, the solenoid valve driving circuit further includes a resistor, which is capable of adjusting an inrush current that flows to the switch controller at a drive start time of the solenoid valve, so as to remain below a maximum value of current flowing through the solenoid coil, wherein a series circuit made up of the resistor and the switch controller, and the solenoid coil, are electrically connected in parallel with respect to the rectifying circuit.

Owing thereto, it becomes possible for the switch controller to be reliably protected from an inrush current, and the solenoid valve can easily be applied as well with respect to an AC power source having a relatively high power source voltage. Further, by carrying out such a countermeasure with respect to the inrush current, unintended or mistaken operations of the solenoid valve driving circuit and the solenoid valve caused by a surge voltage, which is generated momentarily inside the solenoid valve driving circuit at starting and stopping times of the solenoid valve, can reliably be prevented.

Incidentally, in each of the foregoing descriptions, a solenoid valve driving circuit configuration is provided for timewise controlling the supply of a first pulse signal and/or a second pulse signal to the switch, based on a comparison of either the activation current value and/or the holding current value with the current detection value.

On the other hand, in the present invention, it is possible for the supply of the first pulse signal and the second pulse signal to be timewise controlled without utilizing the aforementioned current detection value. The structure of the solenoid valve driving circuit for carrying out such a timewise control is as follows.

Namely, a solenoid valve driving circuit is provided, in which, after a first voltage is impressed on the solenoid coil of a solenoid valve for driving the solenoid valve, a second voltage is impressed on the solenoid coil and a driven state of the solenoid valve is maintained,

the solenoid valve driving circuit being electrically connected, respectively, to an alternating current power source and to the solenoid coil, and further including a rectifying circuit, a switch controller, and a switch,

wherein the rectifying circuit rectifies a power source voltage of the alternating current power source,

wherein the switch controller comprises:

a single pulse generating circuit for generating a single pulse;

a short pulse generating circuit, which, during a time period in which the solenoid valve is driven, generates a first short pulse having a pulse width shorter than a pulse width of the single pulse, whilst, during a time period in which a driven state of the solenoid valve is maintained, generates a second short pulse having a pulse width shorter than the pulse width of the first short pulse; and

a pulse supplying unit, which, during the time period in which the solenoid valve is driven, supplies the first short pulse to the switch as the first pulse signal after the single pulse has been supplied to the switch as a first pulse signal, whilst, during the time period in which the driven state of the solenoid valve is maintained, supplies the second short pulse to the switch as a second pulse signal,

wherein the switch applies the rectified power source voltage as the first voltage to the solenoid coil during a time period when the first pulse signal is supplied thereto, and applies the rectified power source voltage as the second voltage to the solenoid coil during a time period when the second pulse signal is supplied thereto.

In this case, the solenoid valve driving circuit preferably further includes:

a smoothing circuit and a light-emitting diode,

wherein the smoothing circuit, a series circuit made up of the light-emitting diode and the switch controller, and said solenoid coil are electrically connected in parallel with respect to the rectifying circuit, the smoothing circuit smoothes the rectified power source voltage,

the smoothed power source voltage is supplied to the switch controller from the smoothing circuit through the light-emitting diode,

the light-emitting diode is capable of being illuminated when the current flows through the solenoid coil,

the single pulse generating circuit generates the single pulse based on the smoothed power source voltage, and the short pulse generating circuit generates the first short pulse and the second short pulse based on the smoothed power source voltage.

Further, according to the present invention, a solenoid valve driving circuit is provided, in which, after a first voltage is impressed on the solenoid coil of a solenoid valve for driving the solenoid valve, a second voltage is impressed on the solenoid coil and a driven state of the solenoid valve is maintained,

the solenoid valve driving circuit being electrically connected, respectively, to an alternating current power source and to the solenoid coil, and further including a rectifying circuit, a switch controller, and a switch,

wherein the rectifying circuit rectifies a power source voltage of the alternating current power source,

wherein the switch controller comprises:

a single pulse generating circuit for generating a single pulse;

a repeating pulse generating circuit, which, during a time period in which the solenoid valve is driven, generates a first repeating pulse having a pulse width shorter than a pulse width of the single pulse, whilst, during a time period in which a driven state of the solenoid valve is maintained, generates a second repeating pulse having a pulse width shorter than the pulse width of the first repeating pulse; and

a pulse supplying unit, which, during the time period in which the solenoid valve is driven, supplies the first repeating pulse to the switch as a first pulse signal after the single pulse has been supplied to the switch as the first pulse signal, whilst, during the time period in which the driven state of the solenoid valve is maintained, supplies the second repeating pulse to the switch as a second pulse signal,

wherein the switch applies the rectified power source voltage as the first voltage to the solenoid coil during a time period when the first pulse signal is supplied thereto, and applies the rectified power source voltage as the second voltage to the solenoid coil during a time period when the second pulse signal is supplied thereto.

In this case, the solenoid valve driving circuit preferably further includes:

a smoothing circuit and a light-emitting diode,

wherein the smoothing circuit, a series circuit made up of the light-emitting diode and the switch controller, and said solenoid coil are electrically connected in parallel with respect to the rectifying circuit, the smoothing circuit smoothes the rectified power source voltage,

the smoothed power source voltage is supplied to the switch controller from the smoothing circuit through the light-emitting diode,

the light-emitting diode is capable of being illuminated when the current flows through the solenoid coil,

the single pulse generating circuit generates the single pulse based on the smoothed power source voltage, and the repeating pulse generating circuit generates the first repeating pulse and the second repeating pulse based on the smoothed power source voltage.

Furthermore, according to the present invention, a solenoid valve driving circuit is provided in which, after a first voltage is impressed on a solenoid coil of a solenoid valve for driving the solenoid valve, a second voltage is impressed on the solenoid coil and a driven state of the solenoid valve is maintained,

the solenoid valve driving circuit being electrically connected, respectively, to an alternating current power source and to the solenoid coil, and further comprising a rectifying circuit, a smoothing circuit, a light-emitting diode, a switch controller, and a switch,

wherein the smoothing circuit, a series circuit made up of the light-emitting diode and the switch controller, and the solenoid coil are electrically connected in parallel with respect to the rectifying circuit,

wherein the rectifying circuit rectifies a power source voltage of the alternating current power source,

wherein the smoothing circuit smoothes the rectified power source voltage,

wherein the smoothed power source voltage is supplied to the switch controller from the smoothing circuit through the light-emitting diode,

wherein the light-emitting diode is capable of being illuminated when the current flows through the solenoid coil,

wherein the switch controller comprises:

a single pulse generating circuit for generating a single pulse based on the smoothed power source voltage;

a short pulse generating circuit for generating a short pulse having a pulse width shorter than a pulse width of the single pulse, based on the smoothed power source voltage; and

a pulse supplying unit, which, during the time period in which the solenoid valve is driven, supplies the single pulse to the switch as the first pulse signal, whilst, during the time period in which the driven state of the solenoid valve is maintained, supplies the short pulse to the switch as the second pulse signal,

wherein the switch applies the rectified power source voltage as the first voltage to the solenoid coil during a time period when the first pulse signal is supplied thereto, and applies the rectified power source voltage as the second voltage to the solenoid coil during a time period when the second pulse signal is supplied thereto.

Still further, according to the present invention, a solenoid valve driving circuit is provided in which, after a first voltage is impressed on a solenoid coil of a solenoid valve for driving the solenoid valve, a second voltage is impressed on the solenoid coil and a driven state of the solenoid valve is maintained,

the solenoid valve driving circuit being electrically connected, respectively, to an alternating current power source and to the solenoid coil, and further comprising a rectifying circuit, a smoothing circuit, a light-emitting diode, a switch controller, and a switch,

wherein the smoothing circuit, a series circuit made up of the light-emitting diode and the switch controller, and the solenoid coil are electrically connected in parallel with respect to the rectifying circuit,

wherein the rectifying circuit rectifies a power source voltage of the alternating current power source,

wherein the smoothing circuit smoothes the rectified power source voltage,

wherein the smoothed power source voltage is supplied to the switch controller from the smoothing circuit through the light-emitting diode,

wherein the light-emitting diode is capable of being illuminated when the current flows through the solenoid coil,

wherein the switch controller comprises:

a single pulse generating circuit for generating a single pulse based on the smoothed power source voltage;

a repeating pulse generating circuit for generating a repeating pulse having a pulse width shorter than a pulse width of the single pulse, based on the smoothed power source voltage; and

a pulse supplying unit, which, during the time period in which the solenoid valve is driven, supplies the single pulse to the switch as a first pulse signal, whilst, during the time period in which the driven state of the solenoid valve is maintained, supplies the repeating pulse to the switch as a second pulse signal,

wherein the switch applies the rectified power source voltage as the first voltage to the solenoid coil during a time period when the first pulse signal is supplied thereto, and applies the rectified power source voltage as the second voltage to the solenoid coil during a time period when the second pulse signal is supplied thereto.

With this invention, although the structure does not include a current detector, in the event that the activation current value and the holding current value are known beforehand, the first pulse signal and the second pulse signal can be generated based on the activation current value and the holding current value, and by supplying these pulse signals to the switch, a timewise control of the supply of the first pulse signal and/or the second pulse signal with respect to the switch is enabled, such that the aforementioned advantageous of such a timewise control effects can easily be obtained.

In addition, in each of the above solenoid valve driving circuits, the alternating current power source preferably is connected electrically to the rectifying circuit through a switch, a triac, or a phototriac.

Further, preferably, in the case that the alternating current power source is connected electrically with the rectifying circuit through the triac or the phototriac, the rectifying circuit comprises a bridge circuit using diodes, such that when the power source voltage is less than a predetermined voltage value, the diodes are shifted from an ON state into an OFF state.

In the case that the alternating current power source is connected electrically with the rectifying circuit through a contact relay such as the above-mentioned switch, when the switch is placed in an ON state, the power source voltage can be supplied to the rectifying circuit from the alternating current power source for quickly driving the solenoid valve. On the other hand, when the switch is placed in an OFF state, supply of the power source voltage to the rectifying circuit from the alternating current power source is terminated, whereby action of the solenoid valve can be quickly stopped.

By contrast, in the case that the alternating current power source is electrically connected with the rectifying circuit through a non-contact relay such as the triac or the phototriac, as a result of a gate current or light input from the exterior acting as a trigger, the triac or the phototriac is placed in an ON state quickly. However, on the other hand, the current flowing through the triac or the phototriac is lowered until approaching close to 0, and if such a state does not continue for a long period, shifting from an ON state to an OFF state does not take place.

Such a fact is caused by the solenoid coil acting as an inductive load, which causes the current flowing through the triac or the phototriac not to be lowered quickly to the zero level, even if the power source voltage is lowered. Accordingly, if the triac or the phototriac were simply incorporated as is in the solenoid valve, the triac or the phototriac could not be shifted from an ON state into an OFF state within a short time period.

Consequently, the rectifying circuit is configured as a bridge circuit by means of the diodes, such that when the power source voltage of the alternating current power source becomes less than the predetermined voltage value, the diodes are made to shift from an ON state to an OFF state, whereby the current flowing from the alternating current power source in the direction of the rectifying circuit through the triac or the phototriac, or a current flowing in an opposite direction thereto, is rapidly lowered to the vicinity of zero. As a result, the time period for which the current is at the zero level is lengthened, so that the triac or the phototriac can be easily made to shift from the ON state to the OFF state.

Moreover, if the predetermined voltage is a voltage value based on a forward voltage of the diodes constituting the bridge circuit, then since the diodes can be reliably shifted from the ON state to the OFF state, shifting from an ON state of the triac or the phototriac to the OFF state is better facilitated.

Accordingly, in the present invention, because shifting from an ON state to an OFF state of the diodes constituting the rectifying circuit is utilized, whereby the triac can be shifted in a short time from the ON state to the OFF state, a triac or a phototriac can be adopted as the switching means for controlling the electrical connection between the alternating current power source and the rectifying circuit.

Furthermore, the same respective advantageous effects concerning the aforementioned solenoid valve driving circuits can easily be obtained in a solenoid valve as well, to which the above-mentioned various solenoid valve driving circuits have been applied.

The above and other objects, features and advantages of the present invention will become more apparent from the following descriptions when taken in conjunction with the accompanying drawings in which preferred embodiments of the present invention are shown by way of illustrative example.

### BRIEF DESCRIPTION OF THE DRAWINGS

FIG. 1 is a circuit diagram for a solenoid valve according to a first embodiment;

FIG. 2A is a time chart of a relatively low power source voltage in the solenoid valve of FIG. 1;

FIG. 2B is a time chart of a single pulse signal supplied to a pulse supplying unit from a single pulse generating circuit;

FIG. 2C is a time chart of a pulse signal supplied to the pulse supplying unit from a PWM circuit;

FIG. 2D is a time chart of a control signal supplied to a gate terminal of a MOSFET from the pulse supplying unit;

FIG. 2E is a time chart of a voltage impressed on a solenoid coil;

FIG. 2F is a time chart of a current that flows through the solenoid coil;

FIG. 3A is a time chart of a relatively high power source voltage in the solenoid valve of FIG. 1;

FIG. 3B is a time chart of a single pulse signal supplied to a pulse supplying unit from a single pulse generating circuit;

FIG. 3C is a time chart of a pulse signal supplied to the pulse supplying unit from a PWM circuit;

FIG. 3D is a time chart of a control signal supplied to a gate terminal of a MOSFET from the pulse supplying unit;

FIG. 3E is a time chart of a voltage impressed on a solenoid coil;

FIG. 3F is a time chart of a current that flows through the solenoid coil;

FIG. 4 is a circuit diagram for a solenoid valve according to a second embodiment;

FIG. 5 is a circuit diagram for a solenoid valve according to a third embodiment;

FIG. 6 is a circuit diagram for a solenoid valve according to a fourth embodiment

FIG. 7 is a circuit diagram for a solenoid valve according to a fifth embodiment;

FIG. 8 is a circuit diagram for a solenoid valve according to a sixth embodiment;

FIG. 9 is a circuit diagram for a solenoid valve according to a seventh embodiment;

FIG. 10 is a circuit diagram for a solenoid valve according to an eighth embodiment;

FIG. 11 is a circuit diagram for a solenoid valve according to an ninth embodiment; and

FIG. 12 is a circuit diagram for a solenoid valve according to a tenth embodiment.

### DESCRIPTION OF THE PREFERRED EMBODIMENTS

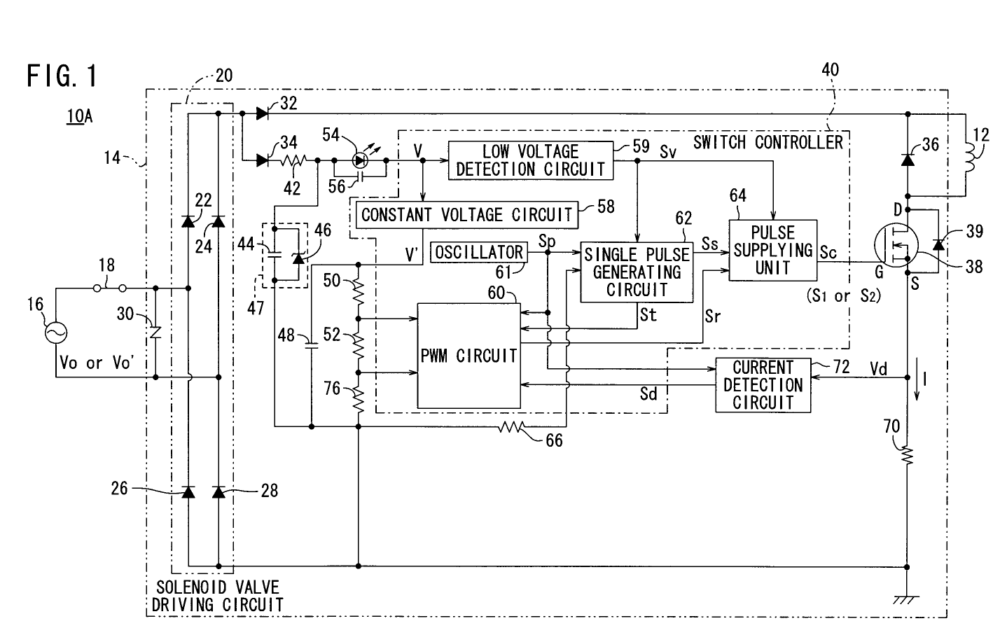

As shown in the circuit diagram of FIG. 1, the solenoid valve 10A according to a first embodiment is equipped with a solenoid valve driving circuit 14 connected electrically with respect to an AC power source 16, and a solenoid coil 12 connected electrically with respect to the solenoid valve driving circuit 14. In this case, one side (the upper side in FIG. 1) of the AC power source 16 is connected electrically to the solenoid coil 12 through a switch 18 and diodes 22, 32 inside of the solenoid valve driving circuit 14, whereas the other side (the lower side in FIG. 1) of the AC power source 16 is connected to ground (earth) through a diode 28 inside of the solenoid valve driving circuit 14.

The solenoid valve driving circuit 14 includes a surge absorber 30, a rectifying circuit 20, diodes 32, 34, 36, 39, a MOSFET (metal oxide semiconductor field effect transistor) 38 serving as a switch, a switch controller 40, resistors 42, 50, 52, 66, 70, 76, condensers 48, 56, a smoothing circuit 47, a light-emitting diode (LED) 54, and a current detection circuit (current detector) 72.

In this case, the solenoid valve driving circuit 14 may be arranged internally in the solenoid valve 10A together with the solenoid coil 12, or alternatively, may be arranged externally of a non-illustrated solenoid valve main body, which accommodates the solenoid coil 12 therein. Accordingly, the solenoid valve 10A may be adopted as a structure in which the solenoid valve driving circuit 14 is connected electrically through a non-illustrated cable to the solenoid coil 12 inside of a commercially available solenoid valve, a structure in which the solenoid valve driving circuit 14 is unitized and attached externally to such a commercially available solenoid valve, or a structure in which the unitized solenoid valve driving circuit 14 is attached externally to a commercially available solenoid valve manifold.

Further, the switch controller 40 includes a constant voltage circuit 58, a low voltage detection circuit 59, a PWM circuit (short pulse generating circuit, repeating pulse generating circuit) 60, an oscillator 61, a single pulse generating circuit 62, and a pulse supplying unit 64. The switch controller 40, the MOSFET 38, the diode 39, and the current detection circuit 72, as mentioned above, can be configured, for example, as a customized IC (integrated circuit).

The surge absorber 30 is connected electrically in parallel with respect to a series circuit made up of the AC power source 16 and the switch 18. Further, the rectifying circuit 20 is connected electrically in parallel with respect to the surge absorber 30. Further, a series circuit made up of the diode 34, the resistor 42, the LED 54, the switch controller 40 and the resistors 50, 52, 76 is connected electrically in parallel with respect to the rectifying circuit 20. Furthermore, a series circuit made up of the diode 32, the solenoid coil 12, the MOSFET 38 and the resistor 70 is connected electrically in parallel with respect to another series circuit made up of the diode 34, the resistor 42, the LED 54, the switch controller 40 and the resistors 50, 52, 76. Still further, the condenser 56 is connected electrically in parallel with the LED 54, the condenser 48 is connected electrically in parallel with respect to a series circuit made up of the resistors 50, 52, 76, the diode 36 is connected electrically in parallel with the solenoid coil 12, and the diode 39 is connected electrically between the drain terminal D and the source terminal S of the MOSFET 38. Still further, the smoothing circuit 47 is configured so that the condenser 44 and a zener diode 46 are electrically connected in parallel, and the smoothing circuit 47 is electrically connected in parallel with respect to a series circuit made up of the LED 54, the switch controller 40 and the resistors 50, 52, 76.

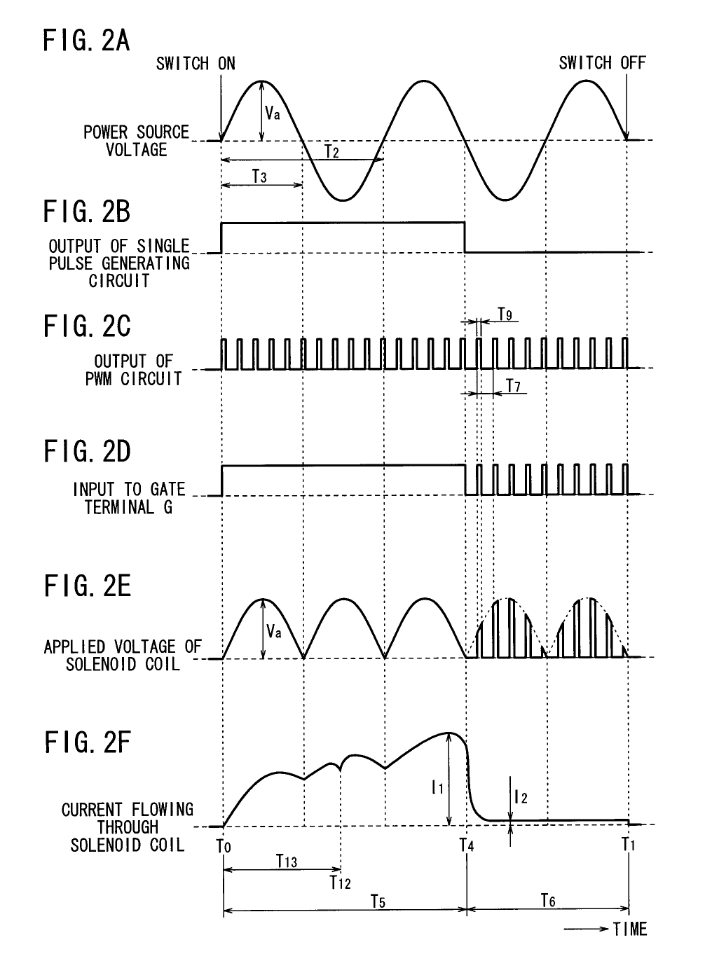

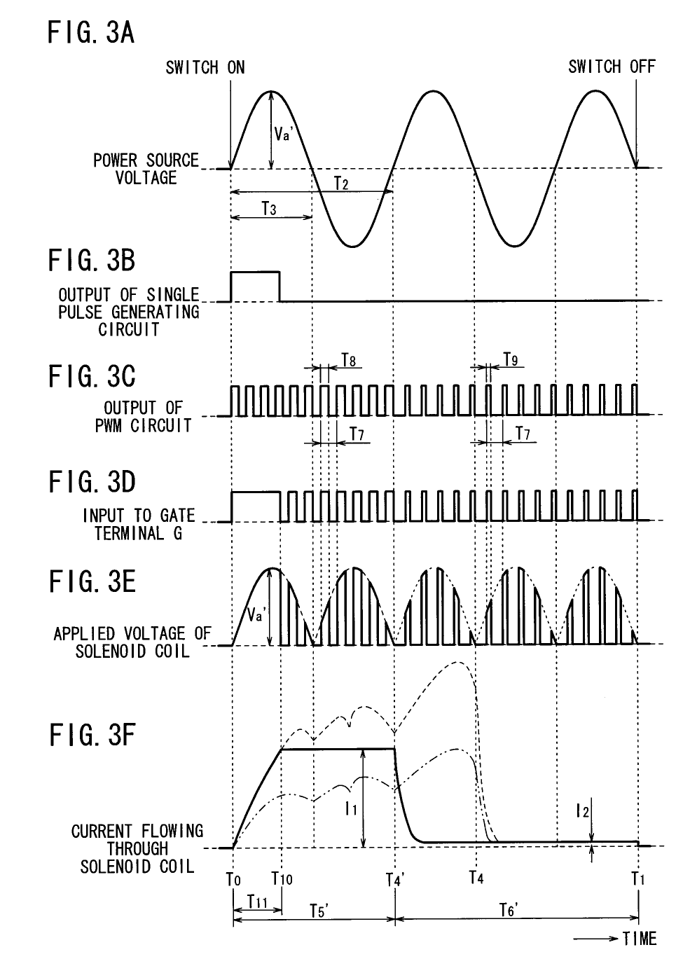

The aforementioned surge absorber 30 acts as a circuit protective voltage-dependent resistor, for causing the surge current that flows in the solenoid valve driving circuit 14 due to the surge voltage to be rapidly channeled to ground, at activation or stoppage times (times T₀ and T₁ shown in FIGS. 2F and 3F) of the solenoid valve 10A when the switch 18 is opened and closed, as a result of the resistance value of the surge absorber 30 momentarily decreasing responsive to the surge voltage, which is momentarily generated inside the solenoid valve driving circuit 14. The surge voltage is defined as a voltage which is larger than a maximum value Va of the power source voltage V₀, or a maximum value Va′ of the power source voltage V₀′, of the AC power source 16 (wherein, V₀<V₀′ and Va<Va′). The power source voltage V₀ is an AC voltage (see FIG. 2A) having a period of time period T₂ (half period: time period T₃) and an amplitude of the maximum value Va, whereas the power source voltage V₀′ is an AC voltage (see FIG. 3A) having a period of time period T₂ (half period: time period T₃) and an amplitude of the maximum value Va′.

The rectifying circuit 20 is formed as a bridge circuit using the diodes 22 through 28, which performs full wave rectification with respect to the power source voltage V₀, V₀′.

The diode 32 is a circuit protective diode for the purpose of preventing current from flowing in the direction of the rectifying circuit 20 through the diode 32 from the solenoid coil 12, and the diode 34 is a circuit protective diode for the purpose of preventing current from flowing in the direction of the rectifying circuit 20 through the diode 34 from the resistor 42. Further, the diode 36 is a diode that refluxes (channels back) a current caused by a back electromotive force generated in the solenoid coil 12 at a stop time (time T₁) of the solenoid valve 10A, in a closed circuit of the solenoid coil 12 and the diode 36, for the purpose of rapidly attenuating the current. Concerning the diode 32, this diode may be replaced by a non-polarized diode bridge (not shown) if desired.

The MOSFET 38 is a semiconductor switching element, which is placed in an ON state between the drain terminal D and the source terminal S at a time when the control signal Sc (first pulse signal S1 or second pulse signal S2) is supplied to the gate terminal G from the switch controller 40, thereby electrically connecting the solenoid coil 12 on the drain terminal side D and the resistor 70 on the source terminal side S. On the other hand, the MOSFET 38 is placed in an OFF state between the drain terminal D and the source terminal S at a time when supply of the control signal Sc is halted with respect to the gate terminal G, whereby the electrical connection between the solenoid coil 12 and the resistor 70 is interrupted.

In the circuit diagram of FIG. 1, as an example of the semiconductor switching element, a case in which an N-channel depression mode MOSFET 38 is adopted is shown. However, the solenoid valve 10A according to the first embodiment is not limited to this arrangement, and any type of semiconductor switching element may be used, which is capable of rapidly switching the electrical connection between the solenoid coil 12 and the resistor 70, corresponding to whether the control signal Sc is being supplied or not. Specifically, in place of the aforementioned MOSFET 38, for example, an N-channel enhancement mode, a P-channel depression mode, or a P-channel enhancement mode MOSFET, a bipolar transistor, or a field effect transistor, may also be adopted as a matter of course.

Further, the diode 39 is a protective diode for the MOSFET 38, which serves to pass the current that flows in the direction of the solenoid coil 12 from the resistor 70.

Furthermore, the aforementioned first pulse signal S1 is defined as a control signal Sc, which is supplied to the gate terminal G of the MOSFET 38 during the time period in which the solenoid valve 10A is driven (i.e., the time periods T₅, T₅′ from time T₀ to times T₄, T₄′ in FIGS. 2F and 3F). On the other hand, the second pulse signal S2 is defined as a control signal Sc, which is supplied to the gate terminal G of the MOSFET 38 during the time period in which the driven state of the solenoid valve 10A is maintained (i.e., the time periods T₆, T₆′ from times T₄, T₄′ to time T₁ in FIGS. 2F and 3F).

The LED 54, during a time period when the switch 18 is in an ON state (i.e., the time period from time T₀ to T₁ shown in FIGS. 2F and 3F), due to the LED 54 becoming illuminated in response to a current flowing in the direction of the switch controller 40 from the resistor 42, provides a notification to the exterior that the solenoid valve 10A is in operation.

The condenser 56 is a bypass condenser for passing high frequency components included within the current that flows in the direction of the switch controller 40 from the resistor 42, whereas the condenser 48 is a bypass condenser for passing high frequency components included within the current that flows in the direction of the resistors 50, 52, 76 from the constant voltage circuit 58.

The smoothing circuit 47 smoothes the power source voltage V₀, V₀′ that has been full wave rectified in the rectifying circuit 20. More specifically, the full wave rectified power source voltage V₀, V₀′ is converted to a constant voltage (DC voltage) having a predetermined value by the zener diode 46, in addition to being smoothed through a charging action of the condenser 44. The power source voltage V₀, V₀′, which has been smoothed in this manner, is supplied as a DC voltage through the LED 54 to the constant voltage circuit 58 and the low voltage detection circuit 59 in the switch controller 40.

Further, the condenser 44 is a condenser capable of adjusting the momentary interruption time of the solenoid valve driving circuit 14 including the switch controller 40 by causing a change in the capacitance thereof, as well as serving as a bypass condenser for draining to ground the high frequency components included within the current that flows from the resistor 42 in the direction of the LED 54, the constant voltage circuit 58, and the low voltage detection circuit 59.

The resistor 42 operates as an inrush current limiting resistor, for the purpose of suppressing an inrush current, which flows in the switch controller 40 when the switch 18 is in an ON state, so as to remain below a rated value (rated current) of the current I flowing through the solenoid coil 12. Accordingly, the resistor 42, by carrying out a countermeasure against the inrush current, functions as a resistor for preventing mistaken operations of the solenoid valve driving circuit 14 and the solenoid valve 10A, caused by the surge voltage generated in the solenoid valve driving circuit 14 at start and stop times of the solenoid valve 10A.

When the current I flows to the resistor 70 from the solenoid coil 12 through the MOSFET 38, a voltage Vd corresponding to the current I is generated at the resistor 70.

Herein, within a time period (refer to FIGS. 2F and 3F) from the time T₀ when the switch 18 is placed in an ON state until the time T₁ when the switch assumes an OFF state, a DC voltage V is impressed on the constant voltage circuit 58 of the switch controller 40 from the smoothing circuit 47 through the LED 54. The constant voltage circuit 58 converts the DC voltage V to a voltage V′ having a predetermined level, and then supplies the voltage V′ to the resistors 50, 52, 76. The DC voltage V represents a DC voltage, which has been reduced from the power source voltage V₀, V₀′, by a voltage drop of the LED 54, etc.

The oscillator 61 outputs a pulse signal Sp having a predetermined repeating frequency (i.e., a repeating frequency corresponding to the period of the time period T₇ of FIGS. 2C and 3C) to the PWM circuit 60, the single pulse generating circuit 62 and the current detection circuit 72, during a time when the DC voltage V is supplied to the switch controller 40, and more specifically, during a time period in which the aforementioned switch 18 is in an ON state.

The low voltage detection circuit 59 monitors whether or not the DC voltage V impressed on the constant voltage circuit 58 is at or below a predetermined voltage level. In the case that the DC voltage has been detected to be at or below the voltage level, a low voltage detection signal Sv indicating that the DC voltage V, which is a drive voltage for operating the switch controller 40, is a relatively low voltage, is output to the single pulse generating circuit 62 and the pulse supplying unit 64.

The single pulse generating circuit 62 generates a single pulse signal Ss having a predetermined pulse width based on the pulse signal Sp from the oscillator 61 and supplies the single pulse signal Ss to the pulse supplying unit 64. In this case, the single pulse generating circuit 62 essentially is preset to count the number of pulses of the pulse signal Sp input from the oscillator 61, and to generate a single pulse signal Ss (see FIG. 2B) having a pulse width (i.e., the pulse width of the time period T₅ shown in FIG. 2F) corresponding to a predetermined count number. However, it is also possible for a single pulse signal Ss (see FIG. 3B) to be generated, which has a predetermined pulse width (i.e., the pulse width of the time period T₁₁ shown in FIG. 3F) corresponding to the resistance value of the resistor 66.

That is, the single pulse generating circuit 62 is a pulse generating circuit that is capable of adjusting the pulse width of the single pulse signal Ss corresponding to the resistance value of the resistor 66. Further, the single pulse generating circuit 62 outputs a notification signal St to the PWM circuit 60, for notifying passage of the time periods T₅, T₅′.

The notification signal St is defined as a signal for notifying the PWM circuit 60 that a shift has occurred from the time period during which the solenoid valve 10A is driven (the time periods T₅, T₅′ shown in FIGS. 2F and 3F) to a time period in which the driven state is maintained (the time periods T₆, T₆′ shown in FIGS. 2F and 3F), which is output to the PWM circuit 60 from the single pulse generating circuit 62 at times T₄ and T₄′. In this case, times T₄, T₄′ are set in the single pulse generating circuit 62 corresponding to an operation of the solenoid valve 10A (first operation or second operation), which shall be described subsequently. Further, in the case that the low voltage detection signal Sv is input from the low voltage detection circuit 59, the single pulse generating circuit 62 halts generation of the single pulse signal Ss and output of the notification signal St.

The current detection circuit 72 samples the voltage Vd of the resistor 70 at the timing of the pulse signal Sp input from the oscillator 61, and the sampled voltage Vd is output as a pulse signal Sd to the PWM circuit 60. As described above, because the voltage Vd represents a voltage that corresponds to the current I flowing through the solenoid coil 12, the amplitude (voltage Vd) of the pulse signal Sd represents a voltage value (current detection value), which is indicative of the current I flowing through the solenoid coil 12.

The PWM circuit 60 generates a pulse signal Sr (first short pulse, first repeating pulse, second short pulse, or second repeating pulse), having a voltage value corresponding to a desired current value (i.e., the first current value (activation current value) I₁ and the second current value (holding current value) 12 shown in FIGS. 2F and 3F) with respect to the current I flowing through the solenoid coil 12, a repeating period (i.e., the time period T₇ shown in FIGS. 2C and 3C) corresponding to the repeating frequency of the pulse signal Sp from the oscillator 61 based on a comparison with the amplitude (voltage Vd) of the pulse signal Sd from the current detection circuit 72, and a predetermined duty ratio (i.e., the ratios T₈/T₇, T₉/T₇ of the time periods T₈, T₉ to the time period T₇) corresponding to the voltage value, and supplies the pulse signal Sr to the pulse supplying unit 64.

In the solenoid valve 10A, within the time periods T₅, T₅′ (refer to FIGS. 2F and 3F), an excitation force (activation force), which is caused by the current I flowing through the solenoid coil 12, is exerted on an unillustrated movable core (plunger) constituting the solenoid valve 10A, as well as on the valve plug that is installed onto an end of the plunger, thereby driving the solenoid valve 10A. On the other hand, during time periods T₆ and T₆′, another excitation force (holding force), which is caused by the current I flowing through the solenoid coil 12, is exerted on the plunger and the valve plug, so that the plunger and the valve plug are held in a predetermined position, whereby the driven state of the solenoid valve 10A is maintained.

In this case, the excitation force (activation force) required for driving the plunger and the valve plug within the time periods T₅, T₅′ which define time periods during which the solenoid valve 10A is driven, or the minimum necessary excitation force (holding force) for holding the plunger and the valve plug in a predetermined position within the time periods T₆, T₆′ which define time periods during which the solenoid valve 10A is maintained in the driven state, are values obtained by multiplying the number of windings (turns) of the solenoid coil 12 and the current I that flows through the solenoid coil 12 (respective excitation forces=number of windings×current I). Therefore, assuming that the activation force needed to drive the solenoid valve 10A, the minimum necessary holding force for maintaining the driven state, and the number of windings, respectively, are known ahead of time, an optimal current value (first current value I₁ as the activation current value) corresponding to the activation force, as well as an optimal current value (second current value I₂ as the holding current value) corresponding to the holding force, can easily be calculated.

Further, during the time periods in which the first pulse signal S1 and the second pulse signal S2 are supplied from the switch controller 40 to the gate terminal G of the MOSFET 38, because the power source voltages V₀, V₀′, which have been full wave rectified in the rectifying circuit 20, are impressed on the solenoid coil 12 as the first or second voltage, and the supply of electrical power to the solenoid coil 12 from the AC power source 16 is carried out through the switch 18, the rectifying circuit 20 and the diode 32, the current I flowing through the solenoid coil 12 increases. On the other hand, during time periods in which supply of the first pulse signal S1 and the second pulse signal S2 from the switch controller 40 to the gate terminal G of the MOSFET 38 is halted, because the supply of electrical power is halted, the current I flowing through the solenoid coil 12 is reduced.

Accordingly, by timewise controlling the supply of the first pulse signal S1 and the second pulse signal S2 with respect to the gate terminal G, the current I flowing through the solenoid coil 12 can be maintained at the desired current value (the first current value I₁ and the second current value I₂).

Consequently, in the solenoid valve driving circuit 14, the voltage Vd corresponding to the current I flowing through the solenoid coil 12 is output from the resistor 70 to the current detection circuit 72, and a pulse signal Sd having the amplitude of the voltage Vd indicated by the current detection value is fed back to the PWM circuit 60 of the switch controller 40 from the current detection circuit 72.

In the PWM circuit 60, based on a comparison between the voltage value corresponding to the current value (first current value I₁) optimal for the activation force and the amplitude (voltage Vd) of the fed back pulse signal Sd, a pulse signal Sr (first repeating pulse or first short pulse) is generated having a repeating period of time T₇ and a duty ratio of T₈/T₇. On the other hand, based on a comparison between the voltage value corresponding to the current value (second current value I₂) optimal for the holding force and the amplitude of the fed back pulse signal Sd, a pulse signal Sr (second repeating pulse or second short pulse) is generated having a repeating period of time T₇ and a duty ratio of T₉/T₇.

As stated above, the duty ratios T₈/T₇ and T₉/T₇ represent duty ratios corresponding to optimal current values (i.e., the first current value I₁ and the second current value I₂), and such duty ratios are set based on the resistance values of the resistors 50, 52, 76. More specifically, the duty ratio T₈/T₇ is a duty ratio corresponding to a predetermined voltage, which is generated by dividing the DC voltage V′ supplied from the constant voltage circuit 58 by each of the resistance values of the resistors 52, 76, whereas the duty ratio T₉/T₇ is a duty ratio corresponding to a predetermined voltage, which is generated by dividing the DC voltage V′ supplied from the constant voltage circuit 58 by each of the resistance values of the resistors 50, 52, 76. Accordingly, in the PWM circuit 60, the duty ratios T₈/T₇ and T₉/T₇ of the pulse signal Sr are adjustable by appropriately changing the resistance values of the resistors 50, 52, 76 corresponding to the sizes of the first current value I₁ and the second current value I₂.

In this case, in the PWM circuit 60, the second repeating pulse or the second short pulse having the duty ratio of T₉/T₇ is generated as the pulse signal Sr (see FIG. 2C). Alternatively, until the notification signal St is received from the single pulse generating circuit 62, the first repeating pulse or the first short pulse having the duty ratio of T₈/T₇ is generated as the pulse signal Sr, whereas, after the notification signal St is received, the second repeating pulse or the second short pulse is generated as the pulse signal Sr (see FIG. 3C).

The first repeating pulse and the first short pulse are pulses having a pulse width (time period T₈) shorter than the pulse width of the single pulse signal Ss (see FIG. 3C). That is, the first repeating pulse is a pulse having a pulse width of the time period T₈, which is generated to repeat at a period of time T₇, whereas the first short pulse is a pulse having a pulse width of the time period T₈.

Further, the second repeating pulse and the second short pulse are pulses having a pulse width (time period T₉) shorter than the pulse widths of the first repeating pulse and the first short pulse (see FIGS. 2C and 3C). That is, the second repeating pulse is a pulse having a pulse width of the time period T₉, which is generated to repeat at a period of time T₇, whereas the second short pulse is a pulse having a pulse width of the time period T₉.

The pulse supplying unit 64 is constructed to include an OR circuit, for example, and serves to supply, as a control signal Sc, the single pulse signal Ss from the single pulse generating circuit 62, or alternatively the pulse signal Sr from the PWM circuit 60, to the gate terminal G of the MOSFET 38. More specifically, the pulse supplying unit 64, at the aforementioned times T₅, T₅′, supplies the single pulse signal Ss or the pulse signal Sr (the first repeating pulse or the first short pulse) as the first pulse signal S1 to the gate terminal G, whereas, at times T₆, T₆′, supplies the pulse signal Sr made up of the second repeating pulse or the second short pulse signal Sr as the second pulse signal S2 to the gate terminal G. Further, in the case that the low voltage detection signal Sv is input from the low voltage detection circuit 59, the pulse supplying unit 64 suspends supply of the first pulse signal S1 or the second pulse signal S2 to the gate terminal G.

The solenoid valve 10A according to the first embodiment is constructed basically as described above. Now, with reference to FIG. 1 through FIG. 3F, operations of the solenoid valve 10A shall be explained.

(1) An operation of the solenoid valve 10A in the case that the first pulse signal S1 having the pulse width of time period T₅ and the second pulse signal S2 (second repeating pulse) having a duty ratio of T₉/T₇ are supplied from the switch controller 40 to the gate terminal G of the MOSFET 38 (hereinafter, first operation), and (2) an operation of the solenoid valve 10A in the case that the single pulse signal Ss having a pulse width of time period T₁₁ and the pulse signal Sr (first repeating pulse) having a duty ratio of T₈/T₇ are supplied as a first pulse signal S1 from the switch controller 40 to the gate terminal G, and thereafter, a pulse signal Sr (second repeating pulse) having a duty ratio of T₉/T₇ is supplied as a second pulse signal S2 from the switch controller 40 to the gate terminal G (hereinafter, second operation), shall be described below with reference to the circuit diagram of FIG. 1 and the time charts of FIGS. 2A through 3F.

Explanations shall be given assuming that, during the first operation, the power source voltage of the AC power source 16 is set at a maximum value Va of the power source voltage V₀, whereas during the second operation, the power source voltage of the AC power source 16 is set at a maximum value Va′ of the power source voltage V₀′. More specifically, the first operation is an operation of the solenoid valve 10A for a case in which, at the side of the user of the solenoid valve 10A, an AC power source 16 having a relatively low power source voltage (e.g., Va≅141 V in the case of an AC power source 16 for use with a 100 V alternating current) is prepared. On the other hand, the second operation is an operation of the solenoid valve 10A for a case in which, at the side of the user of the solenoid valve 10A, an AC power source 16 having a relatively high power source voltage (e.g., Va′≅282 V in the case of an AC power source 16 for use with a 200 V alternating current) is prepared. Further, explanations shall be made, assuming that, during the first operation and the second operation, the amplitude of the single pulse Ss supplied to the pulse supplying unit 64 from the single pulse generating circuit 62 and the amplitude of the pulse signal Sr supplied to the pulse supplying unit 64 from the PWM circuit 60 are substantially at the same level.

First, explanations concerning the first operation shall be given with reference to the circuit diagram of FIG. 1 and the time charts of FIGS. 2A through 2F.

At time T₀, when the switch 18 is closed and the device is placed in an ON state (see FIG. 2A), the power source voltage V₀, which is supplied to the rectifying circuit 20 from the AC power source 16 through the switch 18, is full wave rectified by a bridge circuit made up from the diodes 22 to 28 of the rectifying circuit 20. The full wave rectified power source voltage V₀ is smoothed in the smoothing circuit 47, and the smoothed power source voltage V₀ is applied to the constant voltage circuit 58 and the low voltage detection circuit 59 as a DC voltage via the LED 54. At this time, the LED 54 emits light in response to the current flowing in the direction of the switch controller 40 from the resistor 42, thereby notifying externally of the solenoid valve 10A that the solenoid valve 10A is under operation.

The constant voltage circuit 58 converts the DC voltage V to a predetermined DC voltage V′, and supplies the DC voltage V′ to a series circuit made up of the resistors 50, 52, 76. Further, the low voltage detection circuit 59 monitors whether or not the DC voltage V is at or below a predetermined voltage level. The oscillator 61 generates a pulse signal Sp having a repeating frequency corresponding to the period of the time period T₇, and supplies the pulse signal Sp to the PWM circuit 60, the single pulse generating circuit 62 and the current detection circuit 72.

The single pulse generating circuit 62 generates a single pulse signal Ss having a pulse width of the time period T₅ based on the supply of the pulse signal Sp, and outputs the single pulse signal Ss to the pulse supplying unit 64 (see FIG. 2B).

The current detection circuit 72 carries out sampling, at the timing of the pulse signal Sp, with respect to the voltage Vd that corresponds to the current I in the resistor 70, and the sampled voltage Vd is output as a pulse signal Sd to the PWM circuit 60.

The PWM circuit 60, based on a comparison between the voltage corresponding to the second current value I₂ and the amplitude (voltage Vd) of the pulse signal Sd, generates a pulse signal Sr of the second repeating pulse, having a duty ratio of T₉/T₇ corresponding to the respective resistances of the resistors 50, 52, 76, and further having a repeating period of the time period T₇, and supplies the pulse signal Sr to the pulse supplying unit 64 (see FIG. 2C).

Within the time period T₅ from time T₀ time T₄, a single pulse signal Ss from the single pulse generating circuit 62 is input to the pulse supplying unit 64, and together therewith, the pulse signal Sr is input from the PWM circuit 60. However, as described previously, because the pulse supplying unit 64 is constructed with an OR circuit therein, and since the respective amplitudes of the single pulse signal Ss and the pulse signal Sr are substantially the same amplitude, the pulse supplying unit 64 supplies the single pulse signal Ss as the first pulse signal S1 to the gate terminal G of the MOSFET 38 (see FIG. 2D).

Owing thereto, based on the first pulse signal S1 supplied to the base terminal G, an ON state is formed between the drain terminal D and the source terminal S, whereby the MOSFET 38 is connected electrically to the solenoid coil 12 and the resistor 70. Therefore, the full wave rectified power source voltage V₀ is applied to the solenoid coil 12 as the first voltage from the rectifying circuit 20 through the diode 32 (see FIG. 2E). On the other hand, the current I that flows in the direction of the resistor 70 from the solenoid coil 12 through the MOSFET 38 rapidly increases with the passage of time (see FIG. 2F). As a result, the plunger and valve plug are energized quickly by the excitation force (activation force) caused by the current I, and the solenoid valve 10A shifts from a closed state into an open state.

Further, within the span of the time period T₅, in each of the time intervals T₃, the current I decreases slightly (see FIG. 2F). This is caused by the full wave rectified power source voltage V₀ applied to the solenoid coil 12 decreasing to the zero level in each of the time intervals T₃. Further, at time T₁₂, the current I, which has increased suddenly together with the passage of time, also decreases slightly. This is cause by the plunger being attracted to a non-illustrated fixed iron core, in accordance with the activation force.

Next, at time T₄ immediately after the current I flowing through the solenoid coil 12 has reached the predetermined first current value I₁, the single pulse generating circuit 62 stops generating the single pulse signal Ss, and supply thereof to the pulse supplying unit 64 is suspended (see FIG. 2B). In addition, a notification signal St is output to the PWM circuit 60 notifying that the time T₅ has passed (i.e., that the single pulse signal Ss has been terminated).

On the other hand, the PWM circuit 60, also during the time period T₆ from time T₄ to time T₁, by the same circuit operation noted previously at time T₅, generates the second repeating pulse as the pulse signal Sr, and supplies the same to the pulse supplying unit 64 (see FIG. 2C). In this case, because only the pulse signal Sr is input to the pulse supplying unit 64 from the PWM circuit 60, the pulse supplying unit 64 supplies the pulse signal Sr as the second pulse signal S2 to the gate terminal G of the MOSFET 38 (see FIG. 2D).

Owing thereto, based on the second pulse signal S2 supplied to the gate terminal G, an ON state is formed between the drain terminal D and the source terminal S, whereby the MOSFET 38 is connected electrically to the solenoid coil 12 and the resistor 70. Therefore, the full wave rectified power source voltage V₀ is applied to the solenoid coil 12 as the second voltage from the rectifying circuit 20 and through the diode 32 (see FIG. 2E). On the other hand, the current I that flows in the direction of the resistor 70 from the solenoid coil 12 through the MOSFET 38, decreases rapidly, in a short time period from time T₄, from the first current I₁ to a predetermined second current I₂, and thereafter, the second current I₂ is maintained during the time period until time T₁ (see FIG. 2F). As a result, the plunger and valve plug are held at a predetermined position by the excitation force (holding force) caused by the second current I₂, whereby the driven state (valve open state) of the solenoid valve 10A is maintained.

In addition, at time T₁, when the switch 18 is opened and the device is placed in an OFF state (see FIG. 2A), since the supply of the DC voltage V to the switch controller 40 is suspended, the low voltage detection circuit 59 outputs a low voltage detection signal Sv to the single pulse generating circuit 62 and to the pulse supplying unit 64, whereby, based on input of the low voltage detection signal Sv thereto, the pulse supplying unit 64 stops supplying the second pulse signal S2 to the gate terminal G of the MOSFET 38. Owing thereto, because the MOSFET 38 is rapidly switched from an ON state to an OFF state between the drain terminal D and the source terminal S thereof, a condition is reached in which application of the full wave rectified power source voltage V₀ to the solenoid coil 12 from the rectifying circuit 20 is halted. In this case, although a back electromotive force is generated in the solenoid coil 12, a current caused by the back electromotive force is refluxed (i.e., flows backward) inside of a closed circuit made up of the solenoid coil 12 and the diode 36, so that the current is quickly attenuated.

Next, explanations concerning the second operation shall be given with reference to the circuit diagram of FIG. 1 and the time charts of FIGS. 3A through 3F.

At time T₀, when the switch 18 is closed and the device is placed in an ON state (see FIG. 3A), the power source voltage V₀′ supplied to the rectifying circuit 20 from the AC power source 16 through the switch 18 is full wave rectified by the rectifying circuit 20. The full wave rectified voltage V₀′ is smoothed in the smoothing circuit 47, and the smoothed voltage V₀′ is applied to the constant voltage circuit 58 and the low voltage detection circuit 59 as a direct current voltage V through the LED 54. At this time, the LED 54 emits light in response to the current flowing in the direction of the switch controller 40 from the resistor 42, thereby notifying externally of the solenoid valve 10A that the solenoid valve 10A is under operation.

The constant voltage circuit 58 converts the DC voltage V to a predetermined DC voltage V′, and supplies the DC voltage V′ to a series circuit made up of the resistors 50, 52, 76. Further, the low voltage detection circuit 59 monitors whether or not the DC voltage V is at or below a predetermined voltage level. The oscillator 61 generates a pulse signal Sp having a frequency that is repeated at a period corresponding to the period of the time T₇, and supplies the pulse signal Sp to the PWM circuit 60, the single pulse generating circuit 62, and the current detection circuit 72.

Based on supply of the pulse signal Sp and the resistance value of the resistor 66, the single pulse generating circuit 62 generates and outputs to the pulse supplying unit 64 a single pulse signal Ss having a pulse width of the time period T₁₁ (see FIG. 3B).

The current detection circuit 72 carries out sampling, at the timing of the pulse signal Sp, with respect to the voltage Vd that corresponds to the current I in the resistor 70, and the sampled voltage Vd is output as a pulse signal Sd to the PWM circuit 60.

Based on a comparison between a voltage value corresponding to the first current value I₁ and the amplitude (voltage Vd) of the pulse signal Sd, during a time period T₅′ until the time T₄′ at which the notification signal St from the single pulse generating circuit 62 is input, the PWM circuit 60 generates a pulse signal Sr of the first repeating pulse, having a duty ratio of T₈/T₇ corresponding to the respective resistances of the resistors 50 and 52, and further having a repeating period of the time period T₇, and supplies the pulse signal Sr to the pulse supplying unit 64 (see FIG. 3C).

Within the time period T₁₁ from time T₀ to time T₁₀, a single pulse signal Ss from the single pulse generating circuit 62 is input to the pulse supplying unit 64, and together therewith, the pulse signal Sr is input from the PWM circuit 60. However, as described previously, because the pulse supplying unit 64 is constructed with an OR circuit therein, and since the respective amplitudes of the single pulse signal Ss and the pulse signal Sr are substantially the same amplitude, the pulse supplying unit 64 supplies the single pulse Ss as the first pulse signal S1 to the gate terminal G of the MOSFET 38 (see FIG. 3D).

Owing thereto, based on the first pulse signal S1 supplied to the gate terminal G, an ON state is formed between the drain terminal D and the source terminal S, whereby the MOSFET 38 connects electrically the solenoid coil 12 and the resistor 70. Therefore, the full wave rectified power source voltage V₀′ is applied to the solenoid coil 12 as the first voltage from the rectifying circuit 20 and through the diode 32 (see FIG. 3E). On the other hand, the current I that flows in the direction of the resistor 70 from the solenoid coil 12 through the MOSFET 38 rapidly increases over time within the time period T₁₁ until reaching the first current value I₁ (see FIG. 3F), and the plunger and valve plug are energized quickly by the excitation force (activation force) caused by the current I, whereby the solenoid valve 10A shifts from a closed state into an open state.

Subsequently, at time T₁₀, just after elapse of the time period T₁₁, the single pulse generating circuit 62 stops generating the single pulse signal Ss and supply thereof to the pulse supplying unit 64 is suspended (see FIG. 3B).

On the other hand, the PWM circuit 60, also during the time period from time T₁₀ to time T₄′, by the same circuit operations noted previously at the time period T₁₁, generates the first repeating pulse as the pulse signal Sr, and supplies the same to the pulse supplying unit 64 (see FIG. 3C). In this case, because only the pulse signal Sr is input to the pulse supplying unit 64 from the PWM circuit 60, the pulse supplying unit 64 supplies the pulse signal Sr as the first pulse signal S1 to the gate terminal G of the MOSFET 38 (see FIG. 3D).

Owing thereto, based on the first pulse signal S1 supplied to the gate terminal G, an ON state is formed between the drain terminal D and the source terminal S, whereby the MOSFET 38 connects electrically the solenoid coil 12 and the resistor 70. Therefore, the full wave rectified power source voltage V₀′ is applied to the solenoid coil 12 as a first voltage from the rectifying circuit 20 and through the diode 32 (see FIG. 3E). On the other hand, the current I that flows in the direction of the resistor 70 from the solenoid coil 12 through the MOSFET 38 is maintained at the first current I₁ during the time period from time T₁₀ until time T₄′ (see FIG. 3F).

In FIG. 3F, the waveform shown by the dashed line represents a situation in which feedback control of the current I is not carried out by the solenoid valve driving circuit 14, and shows a timewise change of the current I in the case that application of the full wave rectified power source voltage V₀′ continues until time T₄. On the other hand, the two-dot-dashed line waveform shows a timewise change of the current I during the time period T₅ (i.e., the time period from time T₀ time T₄) of FIG. 2F (i.e., a timewise change of the current I at the relatively low power source voltage V₀).

Herein, an integration over time of the current I flowing through the solenoid coil 12, that is, the partial area (current I×time) surrounded by the time waveform of the current I, the current values at two times, and the zero level (i.e., the dashed line extending in the horizontal direction in FIGS. 2F and 3F), indicates the amount of energy that is supplied to the solenoid coil 12 from the AC power source 16. Accordingly, the energy amounts (current I×times T₅, T₅′) supplied to the solenoid coil 12 from the AC power source 16 during the time periods T₅ and T₅′ from time T₀ times T₄ and T₄′ represents the energy amounts required to drive the solenoid valve 10A.

Because the same solenoid valve 10A is used for both of the above-noted first operation and second operation, the energy amount required to drive the solenoid valve 10A is the same, irrespective of differences in operation. As a result, the timewise integration of the current I during the first operation (the area of the current I×the time T₅) is the same as the timewise integration of the current I during the second operation (the area of the current I×the time T₅′).

Accordingly, assuming that the timewise integrations of the current I (the area of the current I×the times T₅, T₅′) during the first operation and the second operation are adjusted identically, during the second operation (the solid line in FIG. 3F), the current I flowing through the solenoid coil 12 rises to the current level I₁ over a shorter time period than in the first operation (the two-dot-dashed line in FIG. 3F). Additionally, by supplying the energy amount from the AC power source 16 to the solenoid coil 12 within the time period T₅′, which is shorter than the time period T₅ (refer to FIG. 2F), the solenoid valve 10A can be driven in a short time.

Next, at time T₄′, the single pulse generating circuit 62 (see FIG. 1) outputs a notification signal St to the PWM circuit 60, for notifying passage of the time period T₅′. Accordingly, based on the notification signal St, during the time period T₆′ from time T₄′ to time T₁, in place of the aforementioned pulse signal Sr having the duty ratio of T₈/T₇, the PWM circuit 60 generates a pulse signal Sr of the second repeating pulse, having a duty ratio of T₉/T₇, based on the respective resistances of the resistors 50, 52 and 76, and further, having a repeating period of the time period T₇, and supplies the pulse signal Sr to the pulse supplying unit 64 (see FIG. 3C). In this case, because only the pulse signal Sr is input to the pulse supplying unit 64 from the PWM circuit 60, the pulse supplying unit 64 supplies the pulse signal Sr as the second pulse signal S2 to the gate terminal G of the MOSFET 38 (see FIG. 3D).

Owing thereto, based on the second pulse signal S2 supplied to the gate terminal G, an ON state is formed between the drain terminal D and the source terminal S, whereby the MOSFET 38 connects electrically the solenoid coil 12 and the resistor 70. Therefore, the full wave rectified power source voltage V₀′ is applied to the solenoid coil 12 as a second voltage from the rectifying circuit 20 through the diode 32 (see FIG. 3E). On the other hand, concerning the current I that flows in the direction of the resistor 70 from the solenoid coil 12, after being reduced rapidly in a short time period from time T₄′, from the first current value I₁ to the second current value I₂, the current I is maintained at the second current value I₂ during the time period until time T₁ is reached (see FIG. 3F). As a result, the plunger and valve plug are held at a predetermined position by the excitation force (holding force) caused by the second current I₂, whereby the driven state (valve open state) of the solenoid valve 10A is maintained.

In addition, at time T₁, when the switch 18 is opened and the device is placed in an OFF state (see FIG. 3A), since the supply of the DC voltage V to the switch controller 40 is suspended, the low voltage detection circuit 59 outputs a low voltage detection signal Sv to the single pulse generating circuit 62 and to the pulse supplying unit 64, whereby, based on input of the low voltage detection signal Sv thereto, the pulse supplying unit 64 stops supplying the second pulse signal S2 to the gate terminal G of the MOSFET 38. Owing thereto, because the MOSFET 38 is rapidly switched from an ON state to an OFF state between the drain terminal D and the source terminal S thereof, a condition is reached in which application of the full wave rectified voltage V₀′ to the solenoid coil 12 from the rectifying circuit 20 is halted. In this case, although a back electromotive force is generated by the solenoid coil 12, a current caused by the back electromotive force refluxes (i.e., flows backward) inside of a closed circuit made up of the solenoid coil 12 and the diode 36, so that the current is quickly attenuated.

In this manner, in the solenoid valve 10A according to the first embodiment, a voltage Vd corresponding to the current I flowing through the solenoid coil 12 is output from the resistor 70 to the current detection circuit 72, and in the current detection circuit 72, a pulse signal Sd having an amplitude of the voltage Vd serving as a current detection value is fed back to the PWM circuit 60 of the switch controller 40.

In the PWM circuit 60, based on a comparison between the voltage value corresponding to the current value of either the first current value I₁ (activation current value) or the second current value I₂ (holding current value) and the amplitude (voltage Vd) of the fed back pulse signal Sd, a pulse signal Sr (first repeating pulse, first short pulse, second repeating pulse, or second short pulse) is generated having a pulse width of the time period T₇ and a predetermined duty ratio of T₈/T₇ or T₉/T₇, and the pulse signal Sr is supplied to the pulse supplying unit 64.

The pulse supplying unit 64 supplies the single pulse signal Ss from the single pulse generating circuit 62 as the first pulse signal S1 to the gate terminal G of the MOSFET 38, and thereafter, supplies the pulse signal Sr from the PWM circuit 60 as the second pulse signal S2 to the gate terminal G of the MOSFET 38. Alternatively, the pulse supplying unit 64 supplies the single pulse signal Ss and the pulse signal Sr as the first pulse signal S1 to the gate terminal G of the MOSFET 38, and thereafter, supplies the pulse signal Sr as the second pulse signal S2 to the gate terminal G of the MOSFET 38.

More specifically, in the time period (time period T₅, T₅′) during which the solenoid valve 10A is driven, the PWM circuit 60 of the switch controller 40 generates the pulse signal Sr, made up of the first repeating pulse or the first short pulse, and supplies the same to the pulse supplying unit 64, so that the current detection value corresponding to the amplitude (voltage Vd) of the pulse signal Sd becomes the first current value I₁ corresponding to the activation force of the solenoid valve 10A, and the pulse supplying unit 64 supplies the pulse signal Sr as the first pulse signal S1 to the gate terminal G of the MOSFET 38. Owing thereto, the MOSFET 38 controls the application time of the first voltage (full wave rectified power source voltage V₀, V₀′) to the solenoid coil 12 based on the pulse width of the first pulse signal S1. As a result, the current I that flows through the solenoid coil 12 is maintained at the first current value I₁ corresponding to the activation force, while the activation force caused by the current I (first current value I₁) is applied for energizing the plunger and the valve plug.

In greater detail, for a case in which, at the side of the user of the solenoid valve 10A, an AC power source 16 having a relatively high power source voltage V₀′ (e.g., Va′≅282 V in the case of an AC power source 16 for use with a 200 V alternating current) is prepared beforehand, whereas with respect to such an AC power source 16, a solenoid valve 10A is applied that is intended for use with a relatively low power source voltage V₀ (e.g., Va≅141 V in the case of an AC power source 16 for use with a 100 V alternating current), in such a case, in the PWM circuit 60 of the switch controller 40, the first current value I₁ is set to be at or below a rated value (rated current) of the current I that flows through the solenoid coil 12. Assuming the pulse width (time period T₈) of the pulse signal Sr is adjusted such that the current detection value becomes the thus set first current value I₁, then since the current I flowing through the solenoid coil 12 during the time period (time period T₅, T₅′) in which the solenoid valve 10A is driven is maintained at the first current value I₁, even on the side of a user who has prepared an AC power source 16 having the relatively high power source voltage V₀′, electric power savings of the solenoid valve 10A and the solenoid valve driving circuit 14 can be achieved. In this case, because a power source voltage V₀′ corresponding to a relatively high power source voltage V₀′, and which is full wave rectified in the rectifying circuit 20, is applied as the first voltage to the solenoid coil 12, the solenoid valve 10A can be driven in a shorter time.

As described above, since by adjusting the pulse width (time period T₈) of the pulse signal Sr in the PWM circuit 60 of the switch controller 40, the current I flowing through the solenoid coil 12 can be maintained at the first current value I₁ at or below the rated current, on the side of the manufacturer, without concern to differences in the full wave rectified power source voltages V₀, V₀′, which are supplied to the solenoid coil 12 from the AC power source 16, which is prepared on the side of the user, through the rectifying circuit 20, the solenoid valve 10A and the solenoid valve driving circuit 14 can be made commonly usable in conformity with a relatively low power source voltage, and by providing such a commonly usable solenoid valve 10A and solenoid valve driving circuit 14 to the user, costs can be reduced.

Accordingly, with the solenoid valve 10A according to the first embodiment, by generating the pulse signal Sr of the first repeating pulse or the first short pulse based on a comparison between the pulse signal Sd having the voltage Vd corresponding to the current detection value that is fed back to the switch controller 40 from the current detection circuit 72 and the voltage value corresponding to the first current value I₁ during a time period (time period T₅, T₅′) in which the solenoid valve 10A is driven, power savings of the solenoid valve 10A and the solenoid valve driving circuit 14, common usage and cost reduction, and a rapidly-responsive drive control for the solenoid valve 10A, are all capable of being realized.

On the other hand, during a time period (time period T₆, T₆′) in which the driven state of the solenoid valve 10A is maintained, the PWM circuit 60 of the switch controller 40 generates a pulse signal Sr of the second repeating pulse or the second short pulse, so that the current detection value corresponding to the amplitude (voltage Vd) of the pulse signal Sd becomes the second current value I_{2′} corresponding to the holding force for the solenoid valve 10A, whereupon the pulse signal Sr is supplied to the pulse supplying unit 64, and the pulse supplying unit 64 supplies the pulse signal Sr as the second pulse signal S2 to the gate terminal G of the MOSFET 38. Owing thereto, the MOSFET 38 controls the application time during which the second voltage (full wave rectified power source voltage V₀, V₀′) is applied to the solenoid coil 12 based on the pulse width of the second pulse signal S2. As a result, the current I flowing through the solenoid coil 12 is maintained at the second current value I₂ corresponding to the holding force, and the holding force induced by the current I (second current value I₂) is applied to energize the plunger and the valve plug.

Accordingly, with the solenoid valve 10A according to the first embodiment, by generating the pulse signal Sr of the second repeating pulse or the second short pulse based on a comparison between the pulse signal Sd having the voltage Vd corresponding to the current detection value that is fed back to the switch controller 40 from the current detection circuit 72 and the voltage valve corresponding to the second current value I₂ during a time period (time period T₆, T₆′) in which the driven state of the solenoid valve 10A is maintained, the driven state of the solenoid valve 10A can be maintained with smaller power consumption, and further, the solenoid valve 10A can be stopped in a short time.

Further, by feeding back the pulse signal Sd having the voltage Vd corresponding to the current detection value to the PWM circuit 60 of the switch controller 40, even if the current I tends to vary over time due to changes of the electrical resistance inside the solenoid coil 12 or ripples in the full wave rectified power source voltage V₀, V₀′ as a result of temperature changes in the solenoid coil 12, the pulse signal Sr is generated responsive to such changes, whereby the solenoid valve 10A and the solenoid valve driving circuit 14, which are capable of responding to changes in the use environment, such as changes in electrical resistance and the aforementioned ripples or the like, can be realized.

In this manner, with the solenoid valve 10A according to the first embodiment, a reduction in electrical power consumption of the solenoid valve 10A and the solenoid valve driving circuit 14, rapidly responsive drive control for the solenoid valve 10A, and a reduction in costs for the solenoid valve 10A and the solenoid valve driving circuit 14, can all be realized together in one sweep.

Further, with the solenoid valve 10A according to the first embodiment, not only during the time periods (time period T₆, T₆′) in which the driven state of the solenoid valve 10A is maintained, but also during time periods (time period T₅, T₅′) when the solenoid valve 10A is driven, electrical power consumption can be reduced, and therefore, electrical power savings of the solenoid valve 10A and the solenoid valve driving circuit 14 can be carried out with high efficiency.

Furthermore, at the time period (time period T₅, T₅′) during which the solenoid valve 10A is driven, after the full wave rectified power source voltage V₀′ has been impressed as the first voltage on the solenoid coil 12 only at a time period T₁₁ corresponding to the pulse width of the single pulse Ss, the first voltage is impressed on the solenoid coil 12 only at the time period corresponding to the pulse width (time period T₈) of the pulse signal Sr of the first repeating pulse or the first short pulse. As a result, within the time period during which the solenoid valve 10A is driven, after the current I flowing through the solenoid coil 12 has risen up to the first current value I₁ within the time period T₁₁ corresponding to the pulse width of the single pulse signal Ss, the first current value I₁ is maintained by a switching operation of the MOSFET 38 based on the first repeating pulse or the first short pulse. Owing thereto, the solenoid valve 10A and the solenoid valve driving circuit 14 can be made commonly usable, and costs can be reduced easily. In particular, in the case that an AC power source 16, for which the power source voltage V₀′ thereof is relatively high, is electrically connected to the solenoid coil 12 through the solenoid valve driving circuit 14 and the solenoid valve 10A is driven thereby, the solenoid valve 10A is capable of being driven in a shorter time. Further, by maintaining the current I flowing through the solenoid coil 12 at the first current value I₁, unintended or mistaken operations of the solenoid valve 10A and the solenoid valve driving circuit 14 caused by the input of excessive voltage (surge energy) thereto can be reliably prevented.

On the other hand, during a time period (time period T₆, T₆′) at which the driven state of the solenoid valve 10A is maintained, by supplying the pulse signal Sr of the second repeating pulse or the second short pulse as the second pulse signal S2 to the MOSFET 38, the driven state of the solenoid valve 10A can be maintained with lower power consumption, and further, the solenoid valve 10A can be stopped in a short time.

Accordingly, by providing the structure, including the PWM circuit 60, the single pulse generating circuit 62 and the pulse supplying unit 64, for the switch controller 40, common usage and cost reduction of the solenoid valve 10A and the solenoid valve driving circuit 14, driving of the solenoid valve 10A in a short time, power savings of the solenoid valve 10A and the solenoid valve driving circuit 14, and the ability to stop the solenoid valve 10A in a short time, can easily be realized.

Further, in the solenoid valve driving circuit 14, a series circuit made up of the surge absorber 30, the rectifying circuit 20, the diode 34, the resistor 42, the LED 54, the switch controller 40 and the resistors 50, 52, 76, and a series circuit made up of the diode 32, the solenoid coil 12, the MOSFET 38 and the resistor 70, are electrically connected in parallel with respect to a series circuit made up of the AC power source 16 and the switch 18. Furthermore, a series circuit made up of the LED 54, the switch controller 40 and the resistors 50, 52, 76 is connected electrically in parallel with respect to the smoothing circuit 47.

When the LED 54 is incorporated into the solenoid valve driving circuit 14, although it may be considered that a series circuit made up of the LED 54 and a current limiting resistor for causing light to be emitted from the LED 54 could be connected electrically in parallel with respect to the rectifying circuit 20 and the solenoid coil 12, in the present invention, in place of a current limiting resistor, the series circuit including the switch controller 40 and the LED 54 is connected electrically in parallel with respect to the rectifying circuit 20, the smoothing circuit 47 and the solenoid coil 12, whereby, since the electrical energy consumed originally by the current limiting resistor is utilized for operating the switch controller 40, a solenoid valve driving circuit 14 exhibiting high energy use efficiency can be realized.

Further, owing to the arrangement of the resistor 42, it becomes possible for the switch controller 40 to be reliably protected from an inrush current, and in addition, the solenoid valve 10A can easily be applied as well with respect to an AC power source 16 having a relatively high power source voltage V₀′. Further, by carrying out such a countermeasure with respect to the inrush current, unintended or mistaken operations of the solenoid valve 10A and the solenoid valve driving circuit 14 caused by a surge voltage, which is generated momentarily inside the solenoid valve driving circuit 14 at starting and stopping times of the solenoid valve 10A, can reliably be prevented.

Further, in the PWM circuit 60, the duty ratios T₈/T₇ and T₉/T₇ of the pulse signal Sr are adjustable by changing the resistance values of the resistors 50, 52, 76, whereas in the single pulse generating circuit 62, the pulse width of the single pulse signal Ss is adjustable by changing the resistance value of the resistor 66. Owing thereto, irrespective of changes in the power source voltage V₀, V₀′, the switch controller 40 and the MOSFET 38 can be operated stably, and the voltage range (i.e., the range of the power source voltage V₀, V₀′) usable with the solenoid valve driving circuit 14 is capable of being widely set.

Concerning adjustment of the duty ratios T₈/T₇ and T₉/T₇ and the pulse width of the single pulse signal Ss, instead of the aforementioned resistors 50, 52, 66, 76, a non-illustrated memory may be used to store the duty ratios T₈/T₇ and T₉/T₇ and the pulse width of the single pulse signal Ss, and then, as necessary, the duty ratios T₈/T₇ and T₉/T₇ and the pulse width may be read out from the memory to the PWM circuit 60 and the single pulse generating circuit 62. Accordingly, by changing the data stored in the memory, the duty ratios T₈/T₇ and T₉/T₇ and the pulse width can be set appropriately to desired values, corresponding to the specifications of the solenoid valve 10A.

In the above explanations of the solenoid valve 10A according to the first embodiment, within the time period at which the solenoid valve 10A is driven, supply of the first pulse signal S1 is timewise controlled based on a comparison between the voltage value that corresponds to the first current value I₁ and the amplitude (the voltage Vd corresponding to the current detection value) of the pulse signal Sd. On the other hand, within the time period at which the driven state of the solenoid valve 10A is maintained, supply of the second pulse signal S2 is timewise controlled based on a comparison between the current value that corresponds to the second current value I₂ and the amplitude of the pulse signal Sd.

In the solenoid valve 10A according to the first embodiment, it is a matter of course that such a timewise control based on the current detection value can be carried out solely during a time period in which the solenoid valve 10A is driven, or alternatively, during a time period in which the driven state of the solenoid valve 10A is maintained.

More specifically, in order to carry out the timewise control based on the current detection value only during the time period in which the solenoid valve 10A is driven, in the time period (time period T₅′) when the solenoid valve 10A is driven, the solenoid valve 10A is driven based on the aforementioned second operation, whereas, in the time period (time period T₆′) when the driven state of the solenoid valve 10A is maintained, the PWM circuit 60 generates either a predetermined second repeating pulse having a duty ratio of T₉/T₇ and a repeating period of the time period T₇, or a predetermined second short pulse having a pulse width of the time period T₉, and outputs such pulses to the pulse supplying unit 64.

In this manner, even in the event that the timewise control of supply of the first pulse signal S1 with respect to the gate terminal G of the MOSFET 38 is carried out based on the current detection value only during the time period in which the solenoid valve 10A is driven, the above-mentioned effects of the timewise control can easily be obtained.

On the other hand, only during the time period in which the driven state of the solenoid valve 10A is maintained, in order to carry out the timewise control based on the current detection value, the aforementioned first operation is performed. Even in this case as well, wherein the timewise control of the supply of the second pulse signal S2 with respect to the gate terminal G of the MOSFET 38 is carried out based on the current detection value only during the time period in which the driven state of the solenoid valve 10A is maintained, the above-mentioned effects of the timewise control can easily be obtained.

Further, in the solenoid valve 10A according to the first embodiment, although the solenoid valve driving circuit 14 is constructed to include an LED 54 therein, even if the LED 54 is omitted, the aforementioned effects can still be obtained as a matter of course.

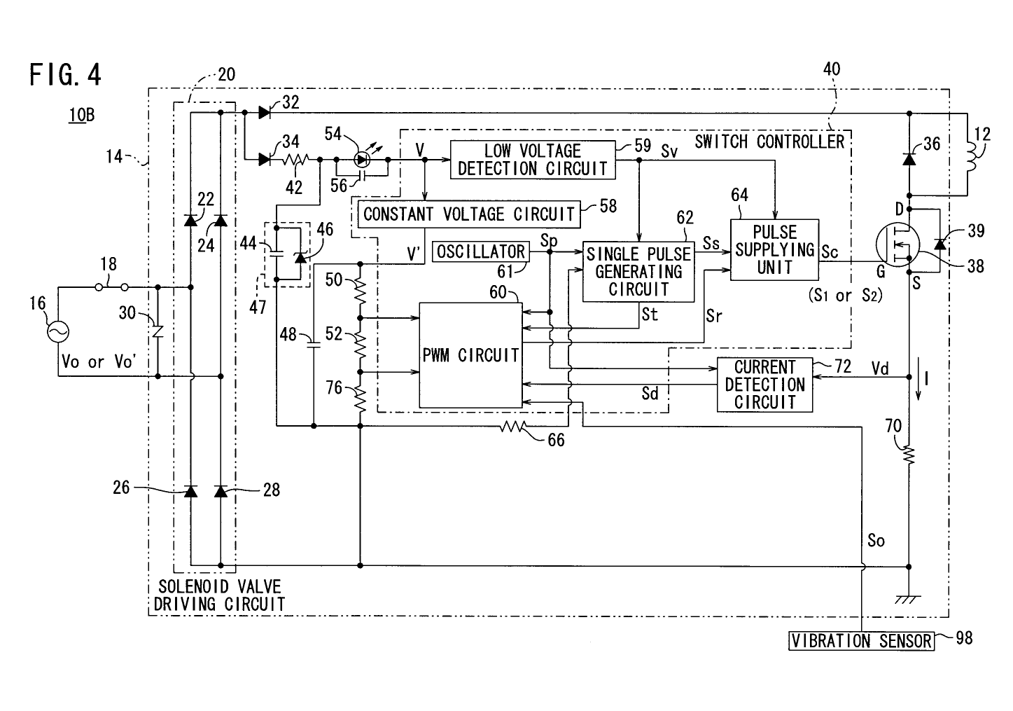

Next, with reference to FIG. 4, explanations shall be given concerning a solenoid valve 10B in accordance with a second embodiment of the present invention. In the following descriptions, constituent elements, which are the same as those in the solenoid valve 10A (see FIGS. 1 to 3F) are designated by the same reference numerals, and detailed explanations of such features shall be omitted.

The solenoid valve 10B according to the second embodiment differs from the solenoid valve 10A according to the first embodiment, in that it includes a vibration sensor (vibration detector) 98.

The vibration sensor 98 detects vibrations generated inside the solenoid valve 10B as a result of vibrations and/or shocks imparted to the solenoid valve 10B from the exterior. Detection results are output as a vibration detection signal So (vibration detection value) to the PWM circuit 60 of the switch controller 40. Based on the vibration detection signal So from the vibration sensor 98, the PWM circuit 60 increases the duty ratio T₉/T₇ (i.e., the pulse width of the time period T₉) of the pulse signal Sr that is supplied to the pulse supplying unit 64 during the time period T₆, T₆′ (refer to FIGS. 2F and 3F). Owing thereto, even if there are concerns that the current I (second current value I₂) flowing through the solenoid coil 12 might change over time due to vibrations inside the solenoid valve 10B, causing stoppage of the solenoid valve 10B during the time period (time period T₆, T₆′) in which the driven state of the solenoid valve 10B is maintained, by increasing the duty ratio T₉/T₇, the current I can be raised.

When the holding force is reduced in order to conserve power, it may be envisaged that vibrations inside the solenoid valve 10B could be caused which might lead to stoppage of the solenoid valve 10B. However, according to the solenoid valve 10B of the second embodiment, by providing the switch controller 40 with the above-noted structure, even if the current I (second current value I₂) flowing through the solenoid coil 12 changes over time due to vibrations inside the solenoid valve 10B, by adjusting the pulse width of the pulse signal Sr (second pulse signal S2) corresponding to such changes, a solenoid valve 10B and solenoid valve driving circuit 14, which are capable of responding to such vibration-induced changes, can be realized.

That is, during the time period (time period T₆, T₆′) in which the driven state of the solenoid valve 10B is maintained, in the event it is feared that the solenoid valve 10B may reach a stopped state due to vibrations, the pulse width (time period T₉) of the pulse signal Sr (second pulse signal S2) is lengthened and the current I (second current value I₂) flowing through the solenoid coil 12 is increased, whereby the holding force on the plunger and the valve plug inside the solenoid valve 10B is made to increase, so that the solenoid valve 10B can be prevented from coming into a stopped state.

Accordingly, in the solenoid valve 10B according to the second embodiment, because the pulse width of the second pulse signal S2 can be set longer so that the level of the current I becomes greater only in those cases when a high holding force is necessary, power savings of the solenoid valve 10B and the solenoid valve driving circuit 14 can be carried out efficiently.

In existing solenoid valves, although it is known to detect valve-open and valve-closed states of the solenoid valve by detection of the pressure inside the solenoid valve utilizing an internal pressure sensor, wherein restarting of the solenoid valve is carried out based on such a detection result, by applying the features of the above-described solenoid valve 10B to the existing solenoid valve, stoppage of the solenoid valve during a time period (time period T₆, T₆′) in which the driven state of the existing solenoid valve is maintained can reliably be prevented.

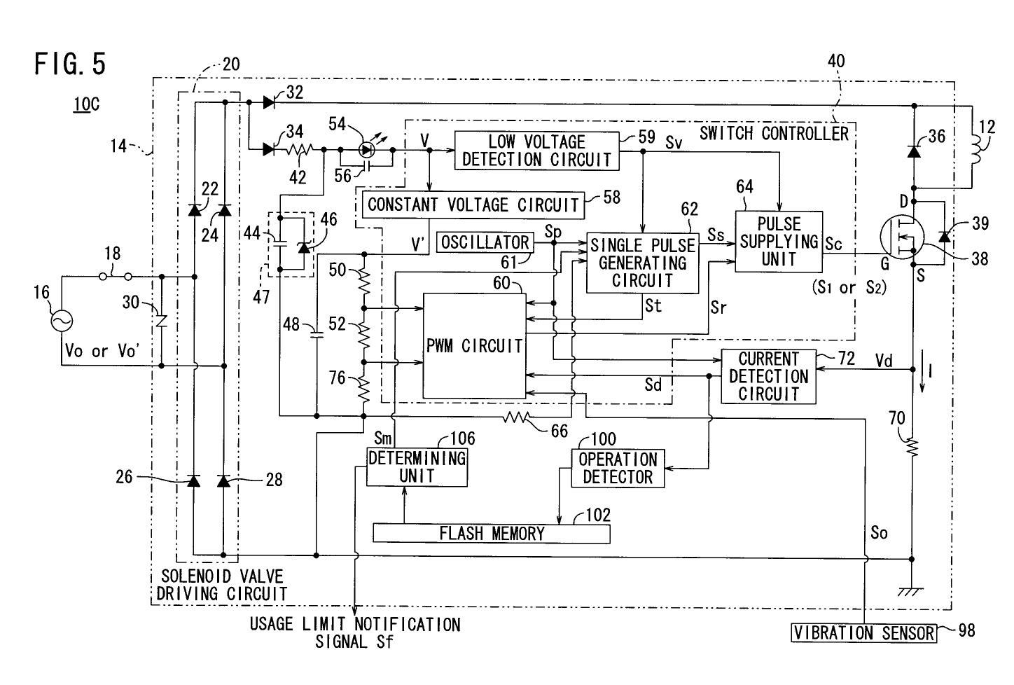

Next, with reference to FIG. 5, explanations shall be given concerning a solenoid valve 10C in accordance with a third embodiment of the present invention.

The solenoid valve 10C according to the third embodiment differs from the solenoid valve 10B according to the second embodiment (see FIG. 4), in that the solenoid valve driving circuit 14 further includes an operation detector (energization time calculator and solenoid valve operation detector) 100, a flash memory (energization time memory and detection result memory) 102, and a determining unit (energization time determining unit and accumulated number of operation times determining unit) 106.

The operation detector 100 includes a counter, which calculates the energization time of the solenoid coil 12 (total time during which the full wave rectified power source voltage V₀, V₀′ is impressed on the solenoid coil 12) in one operational period (the time period from time T₀ to time T₁ in FIGS. 2F and 3F) of the solenoid valve 10C based on the pulse signal Sd, and the detection result is stored in the flash memory 102. Alternatively, the operation detector 100 detects that the solenoid valve 10C is in operation based on the pulse signal Sd, and stores the detection result thereof in the flash memory 102.

The determining unit 106 calculates the total energization time of the solenoid coil 12 based on the totality of the energization time that has been stored in the flash memory 102 after the end of each operation of the solenoid valve 10C, and determines whether or not the total energization time is longer than a predetermined first energization time. Alternatively, the determining unit 106 calculates an accumulated number of operation times of the solenoid valve 10C from each of respective detection results stored in the flash memory 102, and determines whether or not the accumulated number of operation times exceeds a predetermined first number of operation times.

In this case, when the determining unit 106 determines that the total energization time is longer than the predetermined first energization time, or alternatively, that the accumulated number of operation times has exceeded the predetermined first number of operation times, the determining unit 106 outputs a pulse width change signal Sm to the single pulse generating circuit 62 and the PWM circuit 60 of the switch controller 40, instructing that the pulse width (time period T₅, T₁₁) of the single pulse signal Ss and the pulse width (time period T₈) of the pulse signal Sr should be changed. Based on the pulse width change signal Sm, the single pulse generating circuit 62 sets the pulse width of the single pulse signal Ss to be longer than the currently set pulse width. On the other hand, based on the pulse width change signal Sm, the PWM circuit 60 sets the pulse width of the pulse signal Sr to be longer than the currently set pulse width.

Further, when the determining unit 106 determines that the total energization time has become longer than a predetermined second energization time, which is set to be longer than the predetermined first energization time, or alternatively, when the determining unit 106 determines that the accumulated number of operation times exceeds a predetermined second number of operation times, which is set to be greater than the first predetermined number of operation times, the determining unit 106 externally outputs a usage limit notification signal Sf, notifying that the solenoid valve 10C has reached a usage limit.

In this manner, by means of the solenoid valve 10C according to the third embodiment, even in cases where the driving performance of the solenoid valve 10C is decreased through use of the solenoid valve over a prolonged period, by setting the pulse widths of each of the single pulse signal Ss and the pulse signal Sr to be longer at times when the total energization time of the solenoid valve 10C becomes longer than the first energization time, or when the accumulated number of operation times exceeds the first number of operation times, the current I (first current value I₁) flowing through the solenoid coil 12 becomes larger, and the activation force can be increased. Thus, driving control of the solenoid valve 10C can be carried out efficiently.

Further, because the determining unit 106 outputs the usage limit notification signal Sf to the exterior when the total energization time of the solenoid valve 10C becomes longer than the second energization time, or when the accumulated number of operation times exceeds the second number of operation times, it becomes possible to quickly exchange the solenoid valve 10C whenever the usage limit thereof is reached, so that reliability with respect to the usage limit (life) of the solenoid valve 10C is improved.

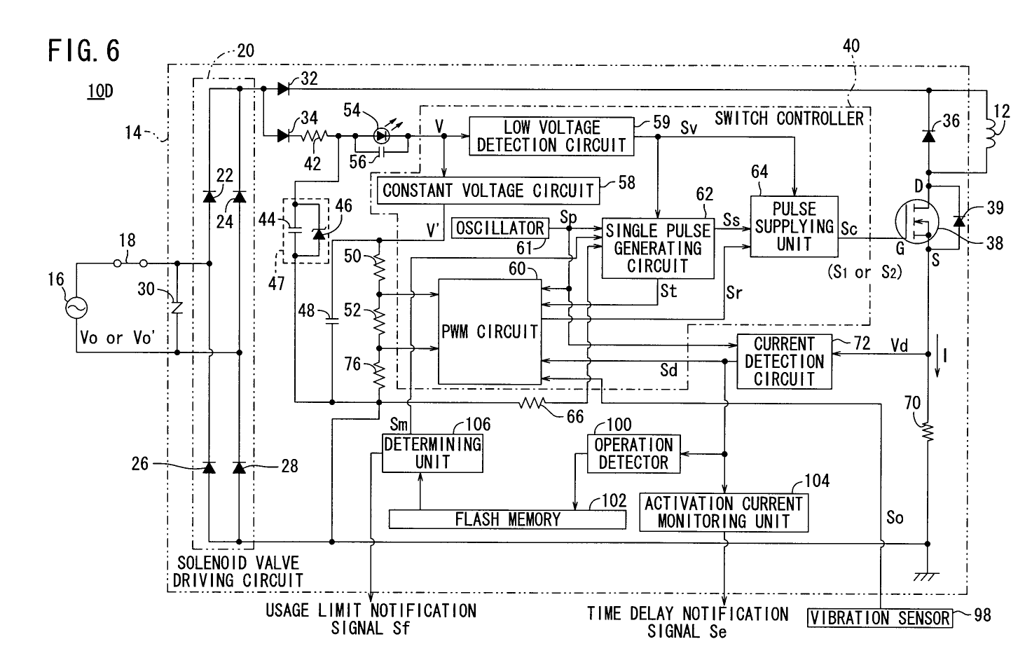

Next, with reference to FIG. 6, explanations shall be given concerning a solenoid valve 10D in accordance with a fourth embodiment of the present invention.

The solenoid valve 10D according to the fourth embodiment differs from the solenoid valve 10C according to the third embodiment (see FIG. 5), in that the solenoid valve driving circuit 14 further includes an activation current monitoring unit (current detection value monitoring unit) 104.

The current detection value monitoring unit 104 monitors a time period T₁₃, from time T₀ to time T₁₂, at which the current I (and the voltage Vd corresponding thereto) slightly decreases during a time period (time period T₅, T₅′) at which the solenoid valve 10D is driven. When it is determined that the time period T₁₃ has become longer than a predetermined set time, a time delay notification signal Se is output to the exterior, for notifying that a time delay was generated in the time period T₁₃.

In this manner, by means of the solenoid valve 10D according to the fourth embodiment, it becomes possible to quickly exchange the solenoid valve 10D for which the time period T₁₃ has become long, and thus the driving performance thereof has degraded. That is, by providing the solenoid valve driving circuit 14 having the aforementioned structure, detection of the usage limit (life) of the solenoid valve 10D can be carried out efficiently, based on the responsiveness of the solenoid valve 10D during the time period at which the solenoid valve is driven.

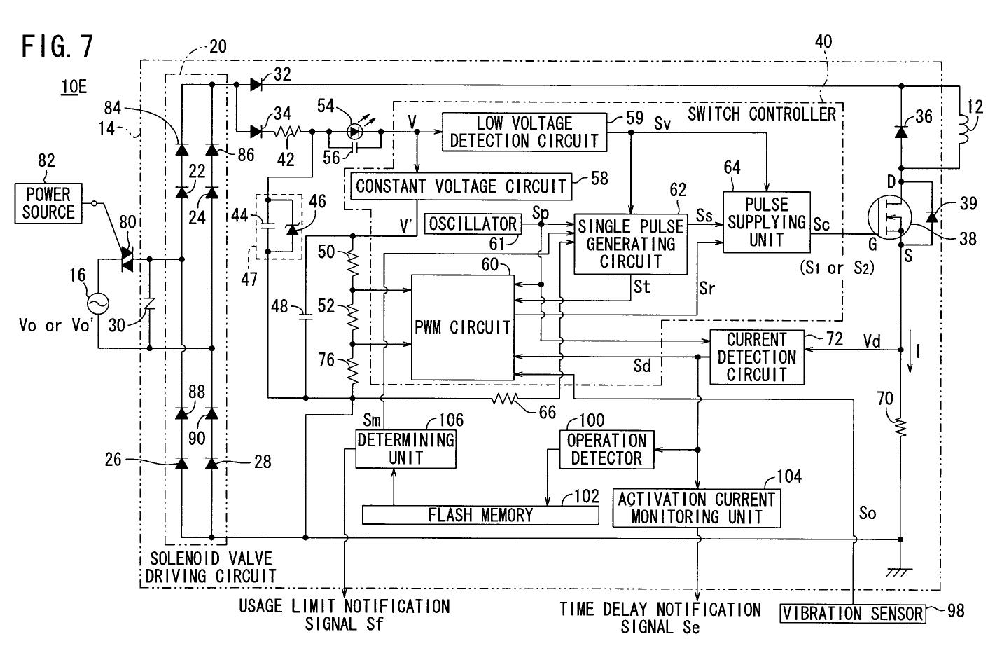

Next, with reference to FIG. 7, explanations shall be given concerning a solenoid valve 10E in accordance with a fifth embodiment of the invention.

The solenoid valve 10E according to the fifth embodiment differs from the solenoid valve 10D according to the fourth embodiment (see FIG. 6), in that the AC power source 16 is connected electrically to the rectifying circuit 20 through a triac 80, and in the rectifying circuit 20, a bridge circuit is constituted by a series circuit made up of diodes 22, 84, a series circuit made up of diodes 24, 86, a series circuit made up of diodes 26, 88, and a series circuit made up of diodes 28, 90.

In this case, the triac 80 is shifted from an OFF state into an ON state by means of the gate current, which is supplied during a predetermined time interval from the power source 82. The time interval is defined as an interval of the time period T₃, starting from a predetermined time (e.g., a predetermined time between the time T₀ and a time at which a time period T₃ has elapsed from the time T₀), apart from the time at which the power source voltage V0, V0′ attains a zero level.

Incidentally, in the solenoid valves 10A to 10D (see FIGS. 1 through 6) according to the aforementioned first through fourth embodiments, the power source voltage V0, V0′ is supplied to the rectifying circuit 20 from the AC power source 16 as a result of the switch 18, which is a contact relay, coming into an ON state, whereby the solenoid valves 10A to 10D can be quickly driven, whereas by bringing the switch 18 into an OFF state, supply of the power source voltage V0, V0′ to the rectifying circuit 20 from the AC power source 16 is terminated, whereby the solenoid valves 10A to 10D can be quickly halted.

In contrast thereto, in the case of the solenoid valve 10E, wherein the AC current source 16 is connected electrically with the rectifying circuit 20 through a non-contact relay such as the triac 80, although the triac 80 is brought into an ON state in a short time owing to the input of the gate current from the power source 82 acting as a trigger, on the other hand, the current flowing through the triac 80 is lowered until approaching close to 0, and if such a state does not continue for a long period, shifting from an ON state to an OFF state does not take place.

Such a fact is caused by the solenoid coil 12 acting as an inductive load, which causes the current flowing through the triac 80 not to be lowered quickly to the zero level, even if the power source voltage V₀, V₀′ is lowered. Accordingly, if the triac 80 were simply incorporated as is into the solenoid valve 10E, the triac 80 could not be shifted from an ON state into an OFF state within a short time period.

Consequently, in the solenoid valve 10E, the rectifying circuit 20 is configured as a bridge circuit by means of the diodes 22 to 28 and 84 to 90, such that when the power source voltage V₀, V₀′ of the AC power source 16 becomes less than the predetermined voltage value, the diodes 22 to 28 and 84 to 90 are made to shift from an ON state to an OFF state, whereby the current flowing from the AC power source 16 in the direction of the rectifying circuit 20 through the triac 80, or a current flowing in an opposite direction thereto, is lowered to the vicinity of zero. As a result, the time period for which the current is at the zero level is lengthened, so that the triac 80 can be easily made to shift from the ON state to the OFF state.

Moreover, if the predetermined voltage is the sum of the forward voltages of the four diodes 22, 28, 84, 90, or alternatively the sum of the forward voltages of the four diodes 24, 26, 86, 88 (i.e., a voltage value based on each of the forward voltages), then since the diodes 22 to 28, 84 to 90 can be reliably shifted from the ON state to the OFF state, shifting from an ON state of the triac 80 to the OFF state is better facilitated.

Accordingly, in the solenoid valve 10E according to the fifth embodiment, because shifting from an ON state to an OFF state of the diodes 22 to 28, 84 to 90 of the rectifying circuit 20 is utilized, whereby the triac 80 can be shifted in a short time from the ON state to the OFF state, the triac 80 can be adopted as a switching means for controlling the electrical connection between the AC power source 16 and the rectifying circuit 20.

Moreover, in the solenoid valve 10E according to the fifth embodiment, the rectifying circuit 20 is constituted by a bridge circuit including a series circuit made up of diodes 22, 84, a series circuit made up of diodes 24, 86, a series circuit made up of diodes 26, 88, and a series circuit made up of diodes 28, 90. However, the invention is not limited to the feature in which the number of diodes on each side of the bridge circuit (i.e., in each of the series circuits) is necessarily two in number, as shown in FIG. 7.

More specifically, assuming the sum of the above-mentioned forward voltages becomes the predetermined voltage value, the number of diodes on each side of the bridge may be one (i.e., each of the individual diodes 22, 24, 26, 28) as in the rectifying circuit 20 in the solenoid valves 10A to 10D (FIGS. 1 to 6) according to the first through fourth embodiments, or alternatively, in the rectifying circuit 20 shown in FIG. 7, in any of one side, two sides or three sides of the four sides of the bridge, the number of diodes may be two in number, whereas in the other remaining side or sides of the bridge, the number of diodes may be one in number. Further, in the rectifying circuit 20, in any one side among the four sides of the bridge the number of diodes may be three, whereas the number of diodes of the other remaining sides of the bridge may be one for each side.

In any event, with the solenoid valve 10E according to the fifth embodiment, in order to reliably control starting and stopping of the solenoid valve 10E, the number of diodes on each side of the bridge in the rectifying circuit 20 can be set appropriately corresponding to the characteristics of the triac 80.

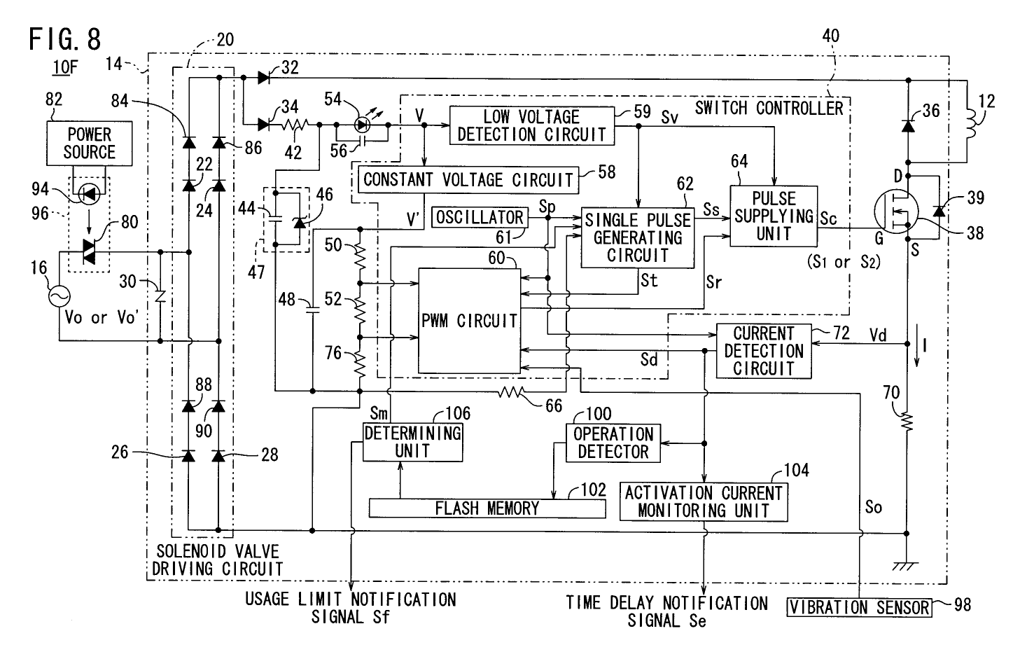

Next, with reference to FIG. 8, explanations shall be given concerning a solenoid valve 10F in accordance with a sixth embodiment of the present invention.

The solenoid valve 10F according to the sixth embodiment differs from the solenoid valve 10E according to the fifth embodiment (see FIG. 7), in that the AC power source 16 is connected electrically to the rectifying circuit 20 through a phototriac 92.

In this case, a photocoupler 96 is constituted by the phototriac 92 and a LED 94, wherein the LED 94 is illuminated intermittently by a current supplied at a predetermined time interval from the power source 82, and wherein the phototriac 92 is shifted into an ON state from the OFF state owing to the intermittently emitted light, which acts as a trigger. The predetermined time interval is the same as the time interval in which the triac 80, in the solenoid valve 10E according to the fifth embodiment (see FIG. 7), is shifted from the OFF state to the ON state.

Incidentally, in the solenoid valve 10F as well, similar to the triac 80, although the phototriac 92 is brought into an ON state in a short time period owing to the light input acting as a trigger, on the other hand, the current flowing through the phototriac 92 is lowered until approaching close to 0, and if such a state does not continue for a long period, shifting from an ON state to an OFF state does not take place. That is, if the phototriac 92 were simply incorporated as is into the solenoid valve 10F, the phototriac 92 could not be shifted from an ON state into an OFF state within a short time period.

Consequently, in the solenoid valve 10F as well, when the power source voltage V₀, V₀′ becomes less than the predetermined voltage value, the diodes 22 to 28, 84 to 90 are made to shift from an ON state to an OFF state, whereby the current flowing from the AC power source 16 in the direction of the rectifying circuit 20 through the phototriac 92, or a current flowing in an opposite direction thereto, is lowered to the vicinity of zero. As a result, the time period for which the current is at the zero level is lengthened, so that the phototriac 92 can easily be made to shift from the ON state to the OFF state.

Moreover, if the predetermined voltage is the sum of the forward voltages of the four diodes 22, 28, 84, 90, or alternatively the sum of the forward voltages of the four diodes 24, 26, 86, 88 (i.e., a voltage value based on each of the forward voltages), then since the diodes 22 to 28, 84 to 90 can be reliably shifted from the ON state to the OFF state, shifting from an ON state of the phototriac 92 to the OFF state is more easily facilitated.

In this manner, in the solenoid valve 10F according to the sixth embodiment, because shifting from an ON state to an OFF state of the diodes 22 to 28, 84 to 90 of the rectifying circuit 20 is utilized, whereby the phototriac 92 can be shifted in a short time from the ON state to the OFF state, the phototriac 92 can be adopted as a switching means for controlling the electrical connection between the AC power source 16 and the rectifying circuit 20.

Moreover, with the solenoid valve 10F according to the sixth embodiment, similar to the solenoid valve 10E (see FIG. 7) according to the fifth embodiment, the number of diodes on each side of the bridge in the rectifying circuit 20 can be set appropriately corresponding to the characteristics of the phototriac 92.

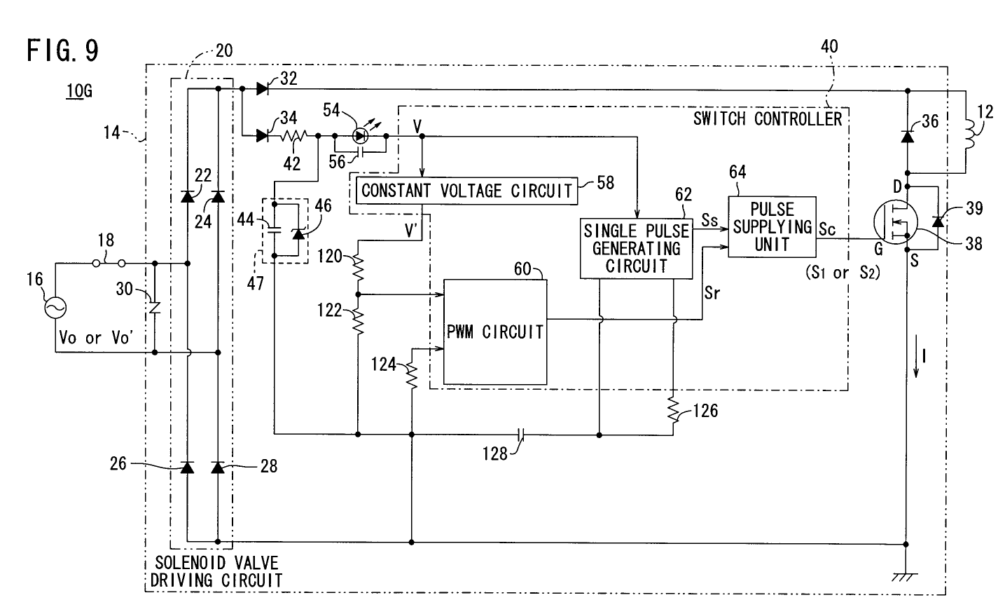

Next, with reference to FIG. 9, explanations shall be given concerning a solenoid valve 10G in accordance with a seventh embodiment of the invention.

The solenoid valve 10G according to the seventh embodiment differs from the solenoid valve 10A according to the first embodiment (see FIG. 1), in that the switch controller 40 is composed of the constant voltage circuit 58, the PWM circuit 60, the signal pulse generating circuit 62 and the pulse supplying unit 64, with the resistors 120 to 126 and the condenser 128 being connected electrically with respect to the switch controller 40, so that accordingly, supply of the control signal Sc (the first pulse signal S1 and the second pulse signal S2) is timewise controlled without the solenoid valve driving circuit 14 utilizing the aforementioned current detection value (i.e., the voltage Vd and pulse signal Sd corresponding thereto).

More specifically, the solenoid valve 10G according to the seventh embodiment differs from the solenoid valve 10A according to the first embodiment (see FIG. 1), in that the solenoid valve 10G is driven, and the driven state thereof is maintained, by roughly the same operation as the aforementioned first operation used in the solenoid valve 10A according to the first embodiment, however, in the event that the first current value I₁ and the second current value I₂ are known beforehand, timewise control of supplying the first pulse signal S1 and the second pulse signal S2 to the gate terminal G of the MOSFET 38 is carried out without utilizing the aforementioned current detection value.

In this case, the duty ratio T₉/T₇ and the repeating period (time period T₇) of the pulse signal Sr supplied to the pulse supplying unit 64 from the PWM circuit 60 are set based on the resistance values of the resistors 120, 122, 124. That is, the repeating period is capable of being adjusted by changing the resistance value of the resistor 124. Further the duty ratio T₉/T₇ is capable of being adjusted by changing the resistance values of the resistors 120 and 122, which is a duty ratio corresponding to predetermined voltages generated by dividing the DC voltage V′ supplied from the constant voltage circuit 58 by each of the resistance values of the resistors 120, 122.

Accordingly, in the PWM circuit 60 of the solenoid valve 10G according to the seventh embodiment, assuming the size of the second current value I₂ is known beforehand, the duty ratio T₉/T₇ and repeating period (time period T₇) of the pulse signal Sr can be adjusted by appropriately changing the resistance values of the resistors 120, 122, 124 corresponding to the size of the second current value I₂.

On the other hand, the single pulse generating circuit 62 generates a single pulse signal Ss having a pulse width of the time period T₅ based on the DC voltage V, the resistance value of the resistor 126, and the capacitance of the condenser 128, and supplies the same to the pulse supplying unit 64. In this case, the pulse width is a pulse width corresponding to the resistance value of the resistor 126 and the capacitance of the condenser 128.

Accordingly, in the single pulse generating circuit 62 of the solenoid valve 10G according to the seventh embodiment, assuming the size of the first current value I₁ is known beforehand, the pulse width (time period T₅) of the single pulse signal Ss can be adjusted by appropriately changing the resistance value of the resistor 126 and the capacitance of the condenser 128 corresponding to the size of the first current value I₁.

During the time period T₅, the pulse supplying unit 64 supplies the signal pulse signal Ss as the first pulse signal S1 to the gate terminal G, whereas, during the time period T₆, the pulse supplying unit 64 supplies the pulse signal Sr as the second pulse signal S2 to the gate terminal G.

In this manner, the solenoid valve 10G according to the seventh embodiment differs from the solenoid valves 10A to 10F according to the first through sixth embodiments (see FIGS. 1 to 8), with a configuration that does not include the resistor 70 and the current detection circuit 72. Notwithstanding, in the case that the first current value I₁ (activation current value) and the second current value I₂ (holding current value) are known beforehand, the first pulse signal S1 (single pulse signal Ss) corresponding to the first current value I₁, and the second pulse signal S2 (pulse signal Sr) corresponding to the second current value I₂, can be generated in the switch controller 40, and can be supplied to the gate terminal G of the MOSFET 38, and thus, supply of the first pulse signal S1 and the second pulse signal S2 with respect to the gate terminal G can be timewise controlled. Accordingly, in the solenoid valve 10G according to the seventh embodiment as well, the advantages and effects in accordance with the aforementioned timewise control discussed in connection with the solenoid valve 10A according to the first embodiment (see FIGS. 1 to 3F) can easily be obtained.

Concerning adjustment of the duty ratio T₉/T₇ and the pulse width of the signal pulse signal Ss, similar to the case of the solenoid valve 10A according to the first embodiment (see FIG. 1), in place of the resistors 120 to 126 and the condenser 128, the duty ratio T₉/T₇ and the pulse width of the signal pulse signal Ss can be stored in an unillustrated memory, whereby the duty ratio T₉/T₇ and the pulse width are capable of being read out, as necessary, from the memory to the PWM circuit 60 and the single pulse generating circuit 62. The duty ratio T₉/T₇ and the pulse width can be set appropriately to desired values by changing the data stored in the memory, corresponding to the specifications of the solenoid valve 10G.

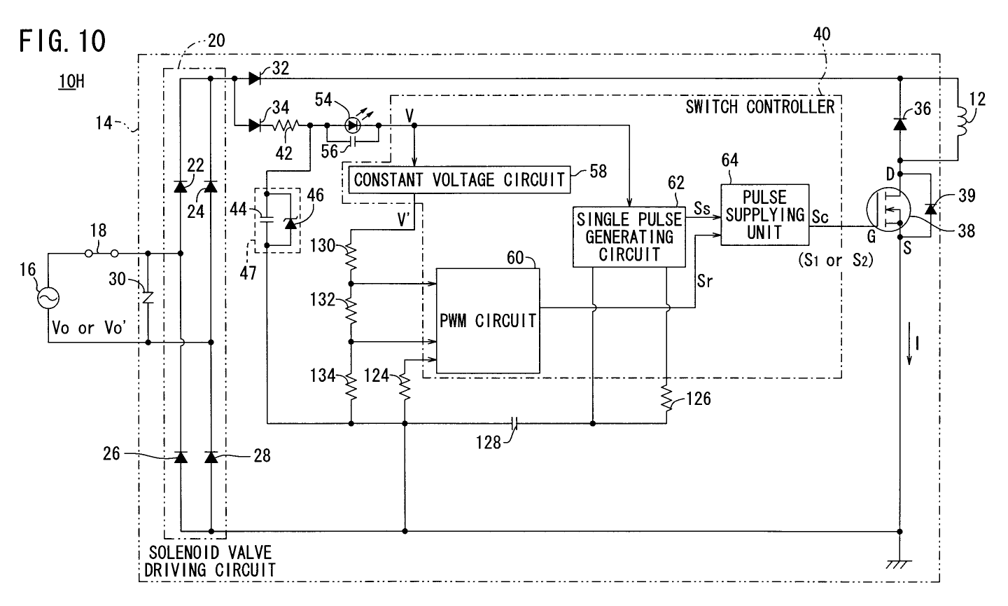

Next, with reference to FIG. 10, explanations shall be given concerning a solenoid valve 10H in accordance with an eighth embodiment of the present invention.

The solenoid valve 10H according to the eighth embodiment differs from the solenoid valve 10G according to the seventh embodiment (see FIG. 9), in that a DC voltage V′ is supplied from the constant voltage circuit 58 to a series circuit made up of the resistors 130, 132, 134.

More specifically, the solenoid valve 10H according to the eighth embodiment differs from the solenoid valve 10A according to the first embodiment (see FIG. 1), in that the solenoid valve 10H is driven, and the driven state thereof is maintained, by roughly the same operation as the aforementioned first operation and second operation used in the solenoid valve 10A according to the first embodiment, however, in the event that the first current value I₁ and the second current value I₂ are known beforehand, timewise control of supplying the first pulse signal S1 and the second pulse signal S2 to the gate terminal G of the MOSFET 38 is carried out without utilizing the aforementioned current detection value.

In this case, the duty ratios T₈/T₇, T₉/T₇ of the pulse signal Sr generated by the PWM circuit 60, similar to the case of the resistors 50, 52, 76 of the solenoid valve 10A according to the first embodiment (see FIG. 1), are set based on the resistance values of the resistors 130, 132, 134.

That is, in the solenoid valve 10H according to the eighth embodiment, the duty ratio T₈/T₇ is a duty ratio corresponding to predetermined voltages generated by dividing the DC voltage V′ supplied from the constant voltage circuit 58 by each of the resistance values of the resistors 132, 134, whereas on the other hand, the duty ratio T₉/T₇ is a duty ratio corresponding to predetermined voltages generated by dividing the DC voltage V′ supplied from the constant voltage circuit 58 by each of the resistance values of the resistors 130, 132, 134. Accordingly, in the PWM circuit 60, the duty ratios T₈/T₇, T₉/T₇ of the pulse signal Sr can be adjusted by appropriately changing the resistance values of the resistors 130, 132, 134 corresponding to the sizes of the first current value I₁ and the second current value I₂.

In addition, in the PWM circuit 60, the second repeating pulse or the second short pulse having the duty ratio T₉/T₇ is generated as the pulse signal Sr (see FIG. 2C), or alternatively, until time T₄′, the first repeating pulse or the first short pulse having the duty ratio T₈/T₇ is generated as the pulse signal Sr, whereas, after time T₄′, the second repeating pulse or the second short pulse having the duty ratio T₉/T₇ is generated as the pulse signal Sr (see FIG. 3C).

The pulse supplying unit 64, during the time periods T₅, T₅′, supplies the single pulse signal Ss or the pulse signal Sr (first repeating pulse or first short pulse) as the first pulse signal S1 to the gate terminal G, whereas during the time periods T₆, T₆′, supplies the pulse signal Sr of the second repeating pulse or the second short pulse as the second pulse signal S2 to the gate terminal G.

In this manner, the solenoid valve 10H according to the eighth embodiment differs from the solenoid valves 10A to 10F according to the first through sixth embodiments (see FIGS. 1 to 8), with a configuration that does not include the resistor 70 and the current detection circuit 72. However, similar to the solenoid valve 10G according to the seventh embodiment, in the case that the first current value I₁ (activation current value) and the second current value I₂ (holding current value) are known beforehand, the first pulse signal S1 (single pulse signal Ss or pulse signal Sr) corresponding to the first current value I₁, and the second pulse signal S2 (pulse signal Sr) corresponding to the second current value I₂, can be generated in the switch controller 40 and can be supplied to the gate terminal G of the MOSFET 38, and thus, supply of the first pulse signal S1 and the second pulse signal S2 with respect to the gate terminal G can be timewise controlled. Accordingly, in the solenoid valve 10H according to the eighth embodiment as well, the advantages and effects in accordance with the aforementioned timewise control discussed in connection with the solenoid valve 10A according to the first embodiment (see FIGS. 1 to 3F) can easily be obtained.

Concerning adjustment of the duty ratios T₈/T₇, T₉/T₇ and the pulse width of the signal pulse signal Ss, similar to the case of the solenoid valve 10G according to the seventh embodiment (see FIG. 9), in place of the resistors 124, 126, 130 to 134 and the condenser 128, the duty ratios T₈/T₇, T₉/T₇ and the pulse width of the signal pulse signal Ss can be stored in an unillustrated memory, whereby the duty ratios T₈/T₇, T₉/T₇ and the pulse width are capable of being read out, as necessary, from the memory to the PWM circuit 60 and the single pulse generating circuit 62. In this case as well, the duty ratios T₈/T₇, T₉/T₇ and the pulse width can be set appropriately to desired values by changing the data stored in the memory, corresponding to the specifications of the solenoid valve 10H.

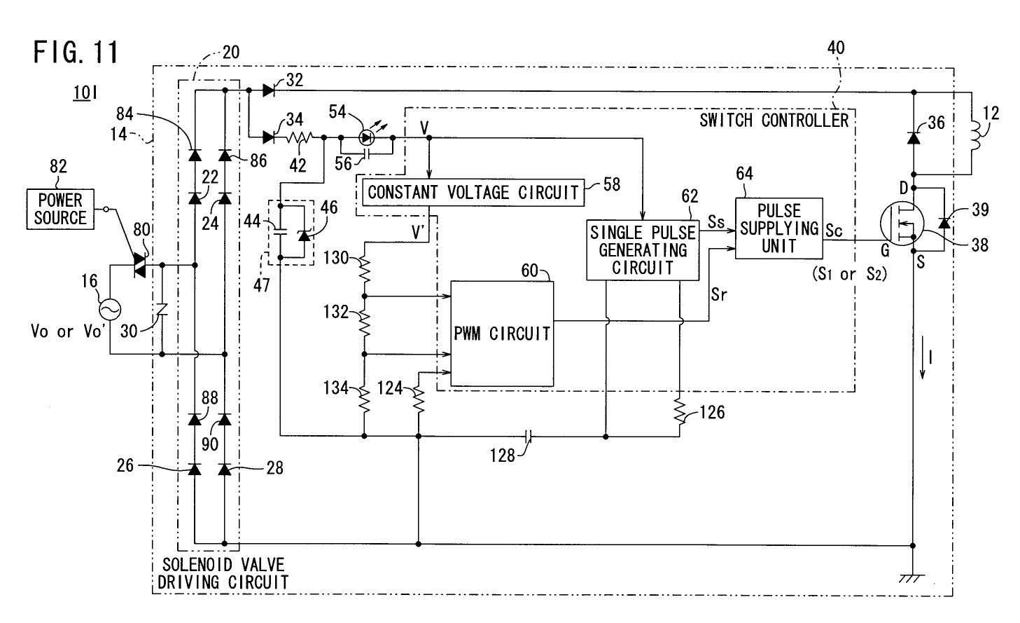

Next, with reference to FIG. 11, explanations shall be given concerning a solenoid valve 10I in accordance with a ninth embodiment of the present invention.

The solenoid valve 10I according to the ninth embodiment differs from the solenoid valve 10H according to the eighth embodiment (see FIG. 10), in that the AC power source 16 is connected electrically to the rectifying circuit 20 through a triac 80, and in the rectifying circuit 20, a bridge circuit is constituted by a series circuit made up of diodes 22, 84, a series circuit made up of diodes 24, 86, a series circuit made up of diodes 26, 88, and a series circuit made up of diodes 28, 90.

In the solenoid valve 10I according to the ninth embodiment, the rectifying circuit 20 is constituted by a bridge circuit made up of the diodes 22 to 28, 84 to 90. Therefore, the same advantages and effects of the solenoid valve 10E (see FIG. 7) according to the fifth embodiment can be obtained.

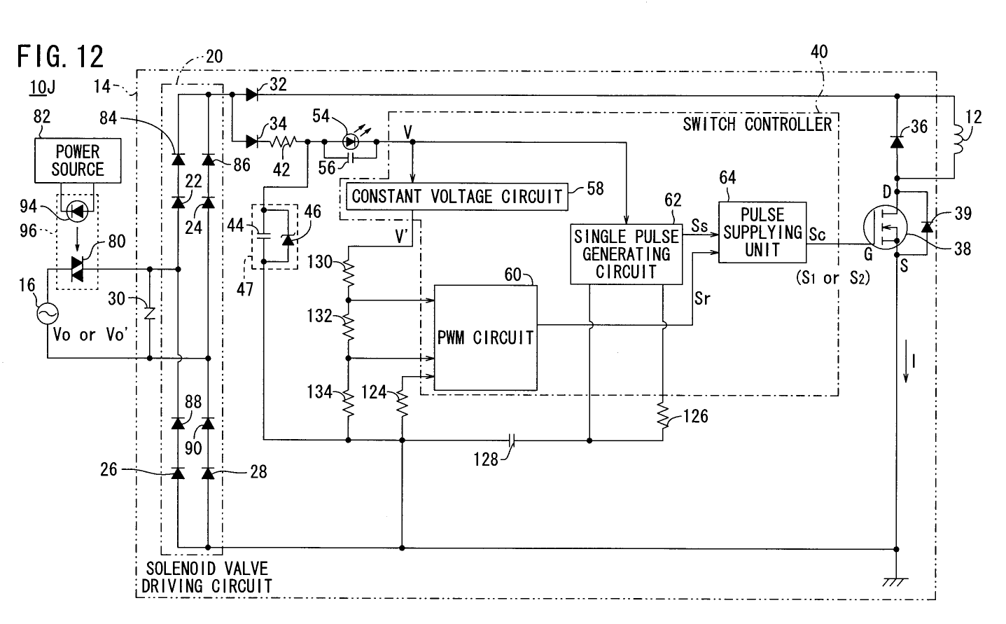

Next, with reference to FIG. 12, explanations shall be given concerning a solenoid valve 10J in accordance with a tenth embodiment of the present invention.

The solenoid valve 10J according to the tenth embodiment differs from the solenoid valve 10I according to the ninth embodiment (see FIG. 11), in that the AC power source 16 is connected electrically to the rectifying circuit 20 through a phototriac 92.

In the solenoid valve 10J according to the tenth embodiment, a photocoupler 96 is constituted by the phototriac 92 and an LED 94, and also the rectifying circuit 20 is constituted by a bridge circuit made up of the diodes 22 to 28, 84 to 90. Therefore, the same advantages and effects of the solenoid valve 10F (see FIG. 8) according to the sixth embodiment can be obtained.

The solenoid valve driving circuit and solenoid valve according to the present invention are not limited to the aforementioned embodiments. Various other structures and configurations may be adopted as a matter of course without deviating from the essence and gist of the present invention.

What is claimed is:

1. A solenoid valve driving circuit in which, after a first voltage is impressed on a solenoid coil of a solenoid valve for driving said solenoid valve, a second voltage is impressed on said solenoid coil and a driven state of said solenoid valve is maintained,
said solenoid valve driving circuit being electrically connected, respectively, to an alternating current power source and to said solenoid coil, and further including a rectifying circuit, a switch controller, a switch, and a current detector,
wherein said rectifying circuit rectifies a power source voltage of said alternating current power source,
wherein said current detector detects a current flowing through said solenoid coil, and outputs a detection result, as a current detection value, to said switch controller,
wherein said switch controller generates a first pulse signal based on a comparison between a predetermined activation current value and the current detection value, and generates a second pulse signal based on a comparison between a predetermined holding current value and said current detection value, and supplies said first pulse signal and said second pulse signal to said switch, and
wherein said switch applies the rectified power source voltage as said first voltage to said solenoid coil during a time period when said first pulse signal is supplied thereto, and applies the rectified power source voltage as said second voltage to said solenoid coil during a time period when said second pulse signal is supplied thereto.

2. The solenoid valve driving circuit according to claim 1, wherein said switch controller comprises:
a single pulse generating circuit for generating a single pulse;
a short pulse generating circuit, which, during a time period in which said solenoid valve is driven, generates a first short pulse having a pulse width shorter than a pulse width of said single pulse based on a comparison between said activation current value and said current detection value, whilst, during a time period in which a driven state of said solenoid valve is maintained, generates a second short pulse having a pulse width shorter than said pulse width of said first short pulse based on a comparison between said holding current value and said current detection value; and
a pulse supplying unit, which, during the time period in which said solenoid valve is driven, supplies said first short pulse to said switch as said first pulse signal after said single pulse has been supplied to said switch as said first pulse signal, whilst, during the time period in which the driven state of said solenoid valve is maintained, supplies said second short pulse to said switch as said second pulse signal.

3. The solenoid valve driving circuit according to claim 1, wherein said switch controller comprises:
a single pulse generating circuit for generating a single pulse;
a repeating pulse generating circuit, which, during a time period in which said solenoid valve is driven, generates a first repeating pulse having a pulse width shorter than a pulse width of said single pulse based on a comparison between said activation current value and said current detection value, whilst, during a time period in which a driven state of said solenoid valve is maintained, generates a second repeating pulse having a pulse width shorter than said pulse width of said first repeating pulse based on a comparison between said holding current value and said current detection value; and
a pulse supplying unit, which, during the time period in which said solenoid valve is driven, supplies said first repeating pulse to said switch as said first pulse signal after said single pulse has been supplied to said switch as said first pulse signal, whilst, during the time period in which the driven state of said solenoid valve is maintained, supplies said second repeating pulse to said switch as said second pulse signal.

4. A solenoid valve driving circuit in which, after a first voltage is impressed on a solenoid coil of a solenoid valve for driving said solenoid valve, a second voltage is impressed on said solenoid coil and a driven state of said solenoid valve is maintained,
said solenoid valve driving circuit being electrically connected, respectively, to an alternating current power source and to said solenoid coil, and further comprising a rectifying circuit, a switch controller, a switch, and a current detector,
wherein said rectifying circuit rectifies a power source voltage of said alternating current power source,
wherein said current detector detects a current flowing through said solenoid coil, and outputs a detection result, as a current detection value, to said switch controller,
wherein said switch controller generates a first pulse signal based on a comparison between a predetermined activation current value and said current detection value, and a predetermined second pulse signal, and supplies said first pulse signal and said second pulse signal to said switch, and
wherein said switch applies the rectified power source voltage as said first voltage to said solenoid coil during a time period when said first pulse signal is supplied thereto, and applies the rectified power source voltage as said second voltage to said solenoid coil during a time period when said second pulse signal is supplied thereto.

5. The solenoid valve driving circuit according to claim 4, wherein said switch controller comprises:
a single pulse generating circuit for generating a single pulse;
a short pulse generating circuit, which, during a time period in which said solenoid valve is driven, generates a first short pulse having a pulse width shorter than a pulse width of said single pulse based on a comparison between said activation current value and said current detection value, whilst, during a time period in which the driven state of said solenoid valve is maintained, generates a second short pulse having a pulse width shorter than said pulse width of said first short pulse; and
a pulse supplying unit, which, during the time period in which the solenoid valve is driven, supplies said first short pulse to said switch as said first pulse signal after the single pulse has been supplied to said switch as said first pulse signal, whilst, during the time period in which the driven state of said solenoid valve is maintained, supplies said second short pulse to said switch as said second pulse signal.

6. The solenoid valve driving circuit according to claim 4, wherein said switch controller comprises:
a single pulse generating circuit for generating a single pulse;
a repeating pulse generating circuit, which, during a time period in which said solenoid valve is driven, generates a first repeating pulse having a pulse width shorter than a pulse width of said single pulse based on a comparison between said activation current value and said current detection value, whilst, during a time period in which the driven state of said solenoid valve is maintained, generates a second repeating pulse having a pulse width shorter than said pulse width of said first repeating pulse; and
a pulse supplying unit, which, during the time period in which said solenoid valve is driven, supplies said first repeating pulse to said switch as said first pulse signal after the single pulse has been supplied to said switch as said first pulse signal, whilst, during the time period in which the driven state of said solenoid valve is maintained, supplies said second repeating pulse to said switch as said second pulse signal.

7. The solenoid valve driving circuit according to claim 1, further comprising a smoothing circuit and a light-emitting diode,
wherein said smoothing circuit, a series circuit made up of said light-emitting diode and said switch controller, and said solenoid coil, are electrically connected in parallel with respect to said rectifying circuit,
said smoothing circuit smoothes the rectified power source voltage,
the smoothed power source voltage is supplied to said switch controller from said smoothing circuit through said light-emitting diode, and
wherein said light-emitting diode is capable of being illuminated when said current flows through said solenoid coil.

8. A solenoid valve driving circuit in which, after a first voltage is impressed on a solenoid coil of a solenoid valve for driving said solenoid valve, a second voltage is impressed on said solenoid coil and a driven state of said solenoid valve is maintained,
said solenoid valve driving circuit being electrically connected, respectively, to an alternating current power source and to said solenoid coil, and further comprising a rectifying circuit, a smoothing circuit, a light-emitting diode, a switch controller, a switch, and a current detector,
wherein said smoothing circuit, a series circuit made up of said light-emitting diode and said switch controller, and said solenoid coil, are electrically connected in parallel with respect to said rectifying circuit,
wherein said rectifying circuit rectifies a power source voltage of said alternating current power source,
wherein said smoothing circuit smoothes the rectified power source voltage,
wherein the smoothed power source voltage is supplied to said switch controller from said smoothing circuit through said light-emitting diode,
wherein said light-emitting diode is capable of being illuminated when said current flows through said solenoid coil,
wherein said current detector detects a current flowing through said solenoid coil, and outputs a detection result, as a current detection value, to said switch controller,
wherein said switch controller generates a predetermined first pulse signal, and a second pulse signal based on a comparison between a predetermined holding current value and said current detection value, and supplies said first pulse signal and said second pulse signal to said switch, and
wherein said switch applies the rectified power source voltage as said first voltage to said solenoid coil during a time period when said first pulse signal is supplied thereto, and applies the rectified power source voltage as said second voltage to said solenoid coil during a time period when said second pulse signal is supplied thereto.

9. The solenoid valve driving circuit according to claim 8, wherein said switch controller comprises:
a single pulse generating circuit for generating a single pulse based on the smoothed power source voltage;
a short pulse generating circuit, which generates a short pulse having a pulse width shorter than a pulse width of said single pulse based on the smoothed power source voltage and a comparison between said holding current value and said current detection value; and
a pulse supplying unit, which, during the time period in which said solenoid valve is driven, supplies said single pulse to said switch as said first pulse signal, whilst, during the time period in which the driven state of said solenoid valve is maintained, supplies said short pulse to said switch as said second pulse signal.

10. The solenoid valve driving circuit according to claim 8, wherein said switch controller comprises:
a single pulse generating circuit for generating a single pulse based on the smoothed power source voltage;
a repeating pulse generating circuit, which generates a repeating pulse having a pulse width shorter than a pulse width of said single pulse based on the smoothed power source voltage and a comparison between said holding current value and said current detection value; and
a pulse supplying unit, which, during the time period in which said solenoid valve is driven, supplies said single pulse to said switch as said first pulse signal, whilst, during the time period in which the driven state of said solenoid valve is maintained, supplies said repeating pulse to said switch as said second pulse signal.

11. The solenoid valve driving circuit according to claim 1, wherein said switch controller adjusts a pulse width of said second pulse signal based on a vibration detection value from a vibration detector, which detects vibration of said solenoid valve.

12. The solenoid valve driving circuit according to claim 1, further comprising:
an energization time calculator for calculating an energization time of said solenoid coil inside of a one-time operating period of said solenoid valve based on said current detection value;
an energization time memory for storing said energization time; and
an energization time determining unit for calculating a total energization time of said solenoid coil from each of respective energization times stored in said energization time memory, and determining whether or not said total energization time is longer than a predetermined first energization time,
wherein said energization time determining unit outputs a pulse width change signal to said switch controller instructing that the pulse width of said first pulse signal be changed, when it is determined that said total energization time is longer than said first energization time, and
wherein said switch controller lengthens the pulse width of said first pulse signal based on said pulse width change signal.

13. The solenoid valve driving circuit according to claim 12, wherein said energization time determining unit externally outputs a usage limit notification signal notifying that said solenoid valve has reached a usage limit, when it is determined that said total energization time is longer than a second energization time, which is set to be longer than said first energization time.

14. The solenoid valve driving circuit according to claim 1, further comprising:
a solenoid valve operation detector for detecting that said solenoid valve is under operation based on said current detection value;
a detection result memory for storing a detection result of said solenoid valve operation detector; and
an accumulated number of operation times determining unit for calculating an accumulated number of operation times of said solenoid valve from each of respective detection results stored in said detection result memory, and determining whether or not said accumulated number of operation times exceeds a predetermined first number of operation times,
wherein said accumulated number of operation times determining unit outputs a pulse width change signal to said switch controller instructing that the pulse width of said first pulse signal be changed, when it is determined that said accumulated number of operation times exceeds said first number of operation times, and
wherein said switch controller lengthens the pulse width of said first pulse signal based on said pulse width change signal.

15. The solenoid valve driving circuit according to claim 14, wherein said accumulated number of operation times determining unit externally outputs a usage limit notification signal notifying that said solenoid valve has reached a usage limit, when it is determined that said accumulated number of operation times exceeds a second number of operation times, which is set to be greater than said first number of operation times.

16. The solenoid valve driving circuit according to claim 1, further comprising:
a current detection value monitoring unit for monitoring a decrease in said current detection value during a time period in which said solenoid valve is driven,
wherein said current detection value monitoring unit externally outputs a time delay notification signal for notifying that there is a time delay in a time period from a drive start time of said solenoid valve to a time at which said current detection value decreases, when said current detection value monitoring unit determines that said time period is longer than a predetermined set time period.

17. The solenoid valve driving circuit according to claim 1, further comprising a resistor, which is capable of adjusting an inrush current that flows to said switch controller at a drive start time of said solenoid valve, so as to remain below a maximum value of current flowing through said solenoid coil, wherein a series circuit made up of said resistor and said switch controller, and said solenoid coil, are electrically connected in parallel with respect to said rectifying circuit.

18. A solenoid valve driving circuit in which, after a first voltage is impressed on the solenoid coil of a solenoid valve for driving said solenoid valve, a second voltage is impressed on said solenoid coil and a driven state of said solenoid valve is maintained,
said solenoid valve driving circuit being electrically connected, respectively, to an alternating current power source and to said solenoid coil, and further including a rectifying circuit, a switch controller, and a switch,
wherein said rectifying circuit rectifies a power source voltage of said alternating current power source,
said switch controller comprising:
a single pulse generating circuit for generating a single pulse;
a short pulse generating circuit which, during a time period in which said solenoid valve is driven, generates a first short pulse having a pulse width shorter than a pulse width of said single pulse, whilst, during a time period in which a driven state of said solenoid valve is maintained, generates a second short pulse having a pulse width shorter than said pulse width of said first short pulse; and
a pulse supplying unit which, during the time period in which said solenoid valve is driven, supplies said first short pulse to said switch as said first pulse signal after said single pulse has been supplied to said switch as a first pulse signal, whilst, during the time period in which the driven state of said solenoid valve is maintained, supplies said second short pulse to said switch as a second pulse signal,
wherein said switch applies the rectified power source voltage as said first voltage to said solenoid coil during a time period when said first pulse signal is supplied thereto, and applies the rectified power source voltage as said second voltage to said solenoid coil during a time period when said second pulse signal is supplied thereto.

19. The solenoid valve driving circuit according to claim 18, further comprising:
a smoothing circuit and a light-emitting diode,
wherein said smoothing circuit, a series circuit made up of said light-emitting diode and said switch controller, and said solenoid coil, are electrically connected in parallel with respect to said rectifying circuit,
said smoothing circuit smoothes the rectified power source voltage,
the smoothed power source voltage is supplied to said switch controller from said smoothing circuit through said light-emitting diode,
said light-emitting diode is capable of being illuminated when current flows through said solenoid coil,
said single pulse generating circuit generates the single pulse based on the smoothed power source voltage, and
said short pulse generating circuit generates said first short pulse and said second short pulse based on the smoothed power source voltage.

20. A solenoid valve driving circuit in which, after a first voltage is impressed on the solenoid coil of a solenoid valve for driving said solenoid valve, a second voltage is impressed on said solenoid coil and a driven state of said solenoid valve is maintained,
said solenoid valve driving circuit being electrically connected, respectively, to an alternating current power source and to said solenoid coil, and further including a rectifying circuit, a switch controller, and a switch,
wherein said rectifying circuit rectifies a power source voltage of said alternating current power source,
said switch controller comprising:
a single pulse generating circuit for generating a single pulse;
a repeating pulse generating circuit which, during a time period in which said solenoid valve is driven, generates a first repeating pulse having a pulse width shorter than a pulse width of said single pulse, whilst, during a time period in which a driven state of said solenoid valve is maintained, generates a second repeating pulse having a pulse width shorter than said pulse width of said first repeating pulse; and
a pulse supplying unit which, during the time period in which said solenoid valve is driven, supplies said first repeating pulse to said switch as a first pulse signal after said single pulse has been supplied to said switch as said first pulse signal, whilst, during the time period in which the driven state of said solenoid valve is maintained, supplies said second repeating pulse to said switch as a second pulse signal,
wherein said switch applies the rectified power source voltage as said first voltage to said solenoid coil during a time period when said first pulse signal is supplied thereto, and applies the rectified power source voltage as said second voltage to said solenoid coil during a time period when said second pulse signal is supplied thereto.

21. The solenoid valve driving circuit according to claim 20, further comprising:
a smoothing circuit and a light-emitting diode,
wherein said smoothing circuit, a series circuit made up of said light-emitting diode and said switch controller, and said solenoid coil, are electrically connected in parallel with respect to said rectifying circuit,
said smoothing circuit smoothes the rectified power source voltage,
the smoothed power source voltage is supplied to said switch controller from said smoothing circuit through said light-emitting diode,
said light-emitting diode is capable of being illuminated when current flows through said solenoid coil,
said single pulse generating circuit generates the single pulse based on the smoothed power source voltage, and
said repeating pulse generating circuit generates said first repeating pulse and said second repeating pulse based on the smoothed power source voltage.

22. A solenoid valve driving circuit in which, after a first voltage is impressed on a solenoid coil of a solenoid valve for driving said solenoid valve, a second voltage is impressed on said solenoid coil and a driven state of said solenoid valve is maintained,
the solenoid valve driving circuit being electrically connected, respectively, to an alternating current power source and to said solenoid coil, and further comprising a rectifying circuit, a smoothing circuit, a light-emitting diode, a switch controller, and a switch,
wherein said smoothing circuit, a series circuit made up of said light-emitting diode and said switch controller, and said solenoid coil, are electrically connected in parallel with respect to said rectifying circuit,
wherein said rectifying circuit rectifies a power source voltage of said alternating current power source,
wherein said smoothing circuit smoothes the rectified power source voltage,
wherein the smoothed power source voltage is supplied to said switch controller from said smoothing circuit through said light-emitting diode,
wherein said light-emitting diode is capable of being illuminated when current flows through said solenoid coil,
said switch controller comprising:
a single pulse generating circuit for generating a single pulse based on the smoothed power source voltage;
a short pulse generating circuit for generating a short pulse having a pulse width shorter than a pulse width of said single pulse, based on the smoothed power source voltage; and
a pulse supplying unit which, during a time period in which said solenoid valve is driven, supplies said single pulse to said switch as said first pulse signal, whilst, during a time period in which the driven state of said solenoid valve is maintained, supplies said short pulse to said switch as said second pulse signal,
wherein said switch applies the rectified power source voltage as said first voltage to said solenoid coil during a time period when said first pulse signal is supplied thereto, and applies the rectified power source voltage as said second voltage to said solenoid coil during a time period when said second pulse signal is supplied thereto.

23. A solenoid valve driving circuit in which, after a first voltage is impressed on a solenoid coil of a solenoid valve for driving said solenoid valve, a second voltage is impressed on said solenoid coil and a driven state of said solenoid valve is maintained,
the solenoid valve driving circuit being electrically connected, respectively, to an alternating current power source and to said solenoid coil, and further comprising a rectifying circuit, a smoothing circuit, a light-emitting diode, a switch controller, and a switch,
wherein said smoothing circuit, a series circuit made up of said light-emitting diode and said switch controller, and said solenoid coil, are electrically connected in parallel with respect to said rectifying circuit,
wherein said rectifying circuit rectifies a power source voltage of said alternating current power source,
wherein said smoothing circuit smoothes the rectified power source voltage,
wherein the smoothed power source voltage is supplied to said switch controller from said smoothing circuit through said light-emitting diode,
wherein said light-emitting diode is capable of being illuminated when current flows through said solenoid coil,
said switch controller comprising:
a single pulse generating circuit for generating a single pulse based on the smoothed power source voltage;
a repeating pulse generating circuit for generating a repeating pulse having a pulse width shorter than a pulse width of said single pulse, based on the smoothed power source voltage; and
a pulse supplying unit which, during a time period in which said solenoid valve is driven, supplies said single pulse to said switch as a first pulse signal, whilst, during a time period in which the driven state of said solenoid valve is maintained, supplies said repeating pulse to said switch as a second pulse signal,
wherein said switch applies the rectified power source voltage as said first voltage to said solenoid coil during a time period when said first pulse signal is supplied thereto, and applies the rectified power source voltage as said second voltage to said solenoid coil during a time period when said second pulse signal is supplied thereto.

24. The solenoid valve driving circuit according to claim 1, wherein said alternating current power source is connected electrically to said rectifying circuit through one of a switch, a triac, and a phototriac.

25. The solenoid valve driving circuit according to claim 24, wherein, in the case that said alternating current power source is connected electrically with the rectifying circuit through said triac or said phototriac, said rectifying circuit comprises a bridge circuit utilizing diodes, such that when said power source voltage is less than a predetermined voltage value, said diodes are shifted from an ON state into an OFF state.

26. A solenoid valve having the solenoid valve driving circuit as set forth in claim 1.
